(19) United States
(12) Patent Application Publication
(10) Pub. No.: US 2024/0291550 A1
(43) Pub. Date: Aug. 29, 2024

(54) SPATIAL COMBINING OF UL IN MIMO SYSTEMS

(71) Applicant: Samsung Electronics Co., Ltd., Suwon-si (KR)

(72) Inventors: Xinliang Zhang, Plano, TX (US); Young Han Nam, Plano, TX (US); Jianzhong Zhang, Dallas, TX (US)

(21) Appl. No.: 18/433,130

(22) Filed: Feb. 5, 2024

Related U.S. Application Data
(60) Provisional application No. 63/448,171, filed on Feb. 24, 2023.
(60) Provisional application No. 63/537,729, filed on Sep. 11, 2023.

(51) Int. Cl. H04B 7/08; H04B 7/0413; H04L 5/00

(52) U.S. Cl. CPC H04B 7/0862; H04B 7/0413; H04L 5/0051

(57) ABSTRACT

A distributed unit (DU) includes a processor and a transceiver operatively coupled to the processor. The transceiver is configured to transmit information indicating a plurality of candidate combining methods, and receive a compressed signal. The compressed signal is based on at least one of the candidate combining methods. The transceiver is further configured to receive, from a radio unit (RU), information indicating a combining method supported by the RU, from the plurality of candidate combining methods and transmit information indicating combining weights for the candidate combining method.

### CROSS-REFERENCE TO RELATED APPLICATION(S) AND CLAIM OF PRIORITY

This application claims priority under 35 U.S.C. § 119(e) to U.S. Provisional Patent Application No. 63/448,171 filed on Feb. 24, 2023, and U.S. Provisional Patent Application No. 63/537,729 filed on Sep. 11, 2023. The above-identified provisional patent applications are hereby incorporated by reference in their entirety.

### TECHNICAL FIELD

This disclosure relates generally to wireless networks. More specifically, this disclosure relates to methods and apparatuses for spatial combining of uplink (UL) in MIMO systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for spatial combining of UL in MIMO systems.

In one embodiment, a distributed unit (DU) is provided. The DU includes a processor and a transceiver operatively coupled to the processor. The transceiver is configured to transmit information indicating a plurality of candidate combining methods and receive a compressed signal. The compressed signal is based on at least one of the candidate combining methods.

In another embodiment, a radio unit (RU) is provided. The RU includes a processor, and a transceiver operatively coupled to the processor. The transceiver is configured to receive information indicating a plurality of candidate combining methods and transmit a compressed signal. The compressed signal is based on at least one of the candidate combining methods.

In yet another embodiment, a method of operating a DU is provided. The method includes transmitting information indicating a plurality of candidate combining methods, and receiving a compressed signal. The compressed signal is based on at least one of the candidate combining methods.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to this disclosure;

FIG. 3A illustrates an example UE according to embodiments of the present disclosure;

FIG. 3B illustrates an example gNB according to embodiments of the present disclosure;

FIG. 4 illustrates example antenna blocks or arrays according to embodiments of the present disclosure;

FIG. 5 illustrates an example base station split over a RU and a DU according to embodiments of the present disclosure;

FIG. 6 illustrates an example of base station signal flows according to embodiments of the present disclosure;

FIG. 7 illustrates a method for UL MIMO data reception according to embodiments of the present disclosure;

FIG. 8 illustrates an example of a massive MIMO antenna panel according to embodiments of the present disclosure;

FIG. 9 illustrates an example of base station signal flows according to embodiments of the present disclosure;

FIG. 10 illustrates a method for UL MIMO data reception according to embodiments of the present disclosure;

FIG. 11 illustrates an example of a method of M-plane signaling according to embodiments of the present disclosure;

FIG. 12 illustrates an example of an extremely massive MIMO antenna panel according to embodiments of the present disclosure;

FIG. 13 illustrates an example of port group dimensions according to embodiments of the present disclosure;

FIG. 14 illustrates an example of port group dimensions according to embodiments of the present disclosure;

FIG. 15 illustrates an example of a section extension according to embodiments of the present disclosure;

FIG. 16 illustrates an example of port group division signaling and decoding according to embodiments of the present disclosure;

FIG. 17 illustrates an example of port-group division and the order of a port-group with 256 digital ports according to embodiments of the present disclosure;

FIG. 18 illustrates an example of a section extension according to embodiments of the present disclosure;

FIG. 19 illustrates an example of a section extension according to embodiments of the present disclosure;

FIG. 20 illustrates an example of a section extension according to embodiments of the present disclosure;

FIG. 21 illustrates an example of a section extension according to embodiments of the present disclosure;

FIG. 22 illustrates an example of a section extension according to embodiments of the present disclosure;

FIG. 23 illustrates an example of C-plane signaling with codebook based spatial combining according to embodiments of the present disclosure;

FIG. 24 illustrates an example of SE1 used for C-plane signaling with codebook based spatial combining according to embodiments of the present disclosure;

FIG. 25 illustrates an example of SE Y1 used for C-plane signaling with codebook based spatial combining according to embodiments of the present disclosure;

FIG. 26 illustrates an example of C-plane signaling with free-form spatial combining according to embodiments of the present disclosure;

FIG. 27 illustrates an example of SE10 used for C-plane signaling with codebook based spatial combining according to embodiments of the present disclosure;

FIG. 28 illustrates an example of C-plane signaling for spatial combining according to embodiments of the present disclosure;

FIG. 29 illustrates examples of serial spatial combining according to embodiments of the present disclosure;

FIG. 30 illustrates examples of parallel spatial combining according to embodiments of the present disclosure;

FIG. 31 illustrates examples of hybrid spatial combining according to embodiments of the present disclosure;

FIG. 32 illustrates an example of SE Z used for signaling for hybrid spatial combining according to embodiments of the present disclosure;

FIG. 33 illustrates an example of using SE Z and SE per method to transfer the spatial combining configuration according to embodiments of the present disclosure;

FIG. 34 illustrates an example of multiple spatial combining options according to embodiments of the present disclosure;

FIG. 35 illustrates an example of using SE Z to transfer multiple spatial combining options according to embodiments of the present disclosure;

FIG. 36 illustrates examples of using SE Z to transfer multiple spatial combining options according to embodiments of the present disclosure;

FIG. 37 illustrates an example 3700 of multiple options of parameters for spatial combining weights according to embodiments of the present disclosure; and

FIG. 38 illustrates a method for spatial combining of UL in MIMO systems according to embodiments of the present disclosure.

### DETAILED DESCRIPTION

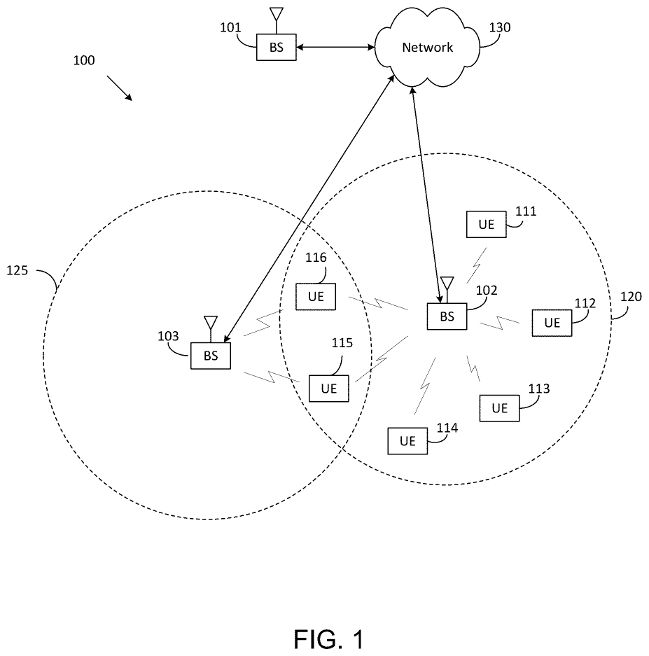

FIGS. 1 through 38, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for spatial combining of UL in MIMO systems. In certain embodiments, one or more of the gNBs 101-103 includes circuitry, programing, or a combination thereof, to support spatial combining of UL in MIMO systems in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

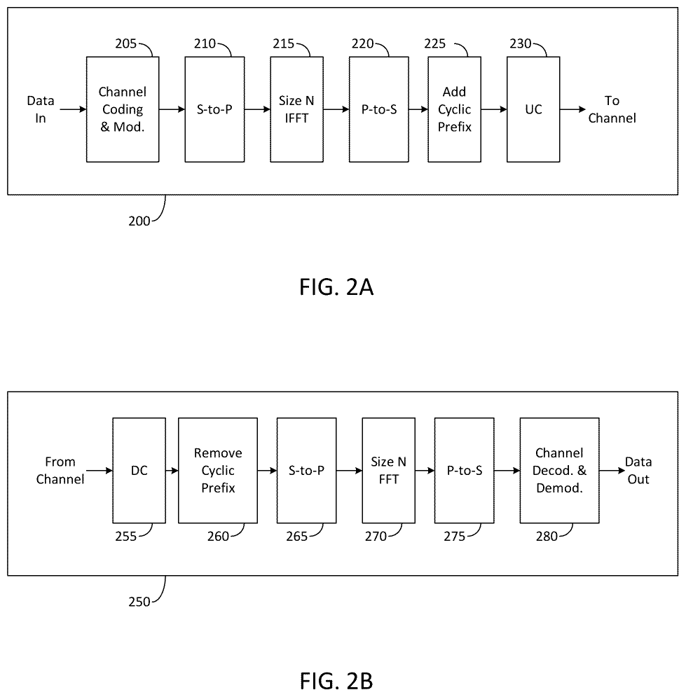

FIGS. 2A and 2B illustrate example wireless transmit and receive paths according to this disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the receive path 250 is configured to support spatial combining of UL in MIMO systems as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

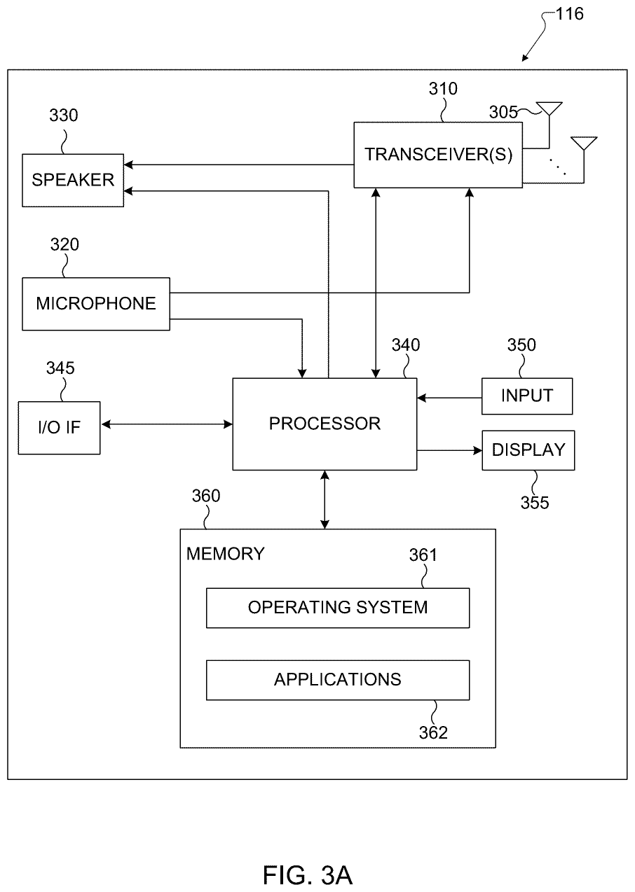

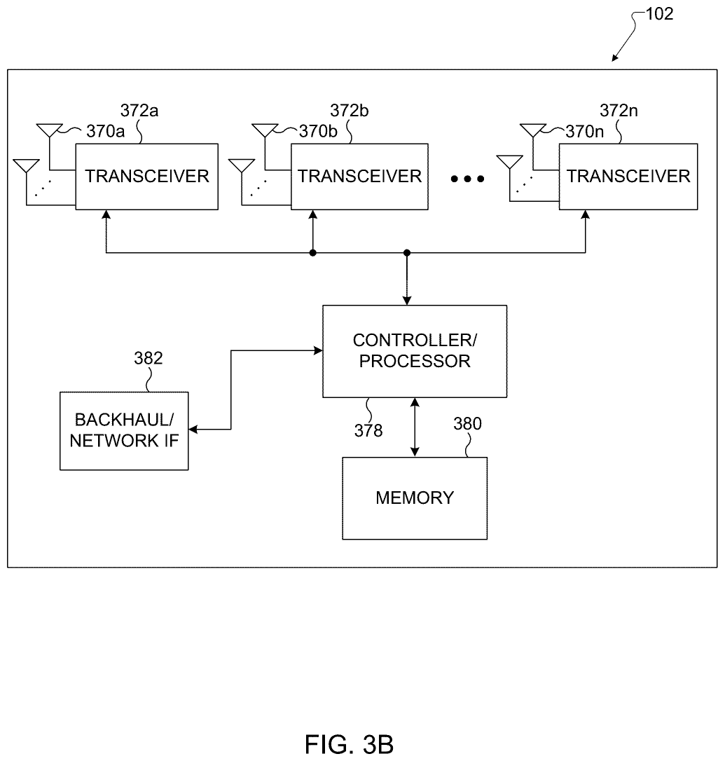

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for spatial combining of UL in MIMO systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support spatial combining of UL in MIMO systems as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

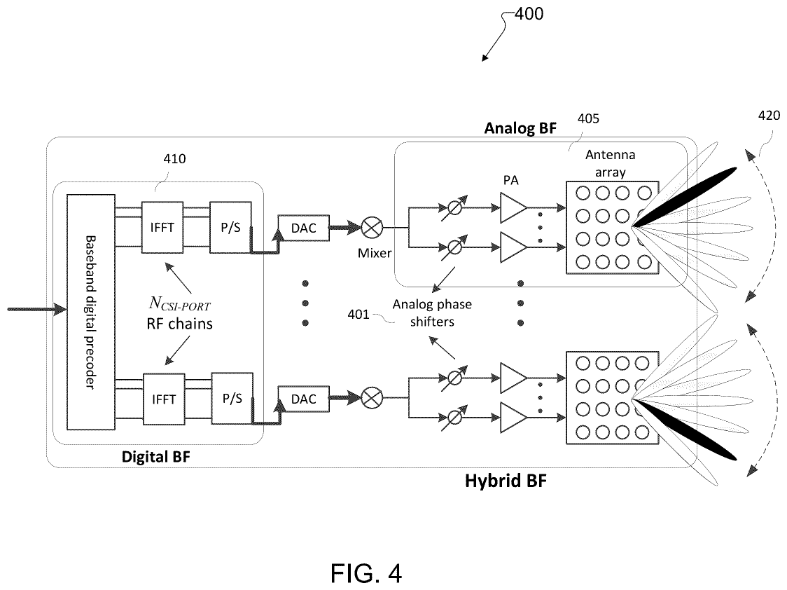

FIG. 4 illustrates example antenna blocks or arrays 400 according to embodiments of the present disclosure. The embodiment of the antenna blocks or arrays 400 illustrated in FIG. 4 is for illustration only. Different embodiments of antenna blocks or arrays 400 could be used without departing from the scope of this disclosure.

Rel-14 LTE and Rel-15 NR support up to 32 CSI-RS antenna ports which enable an eNB or a gNB to be equipped with a large number of antenna elements (such as 64 or 128). A plurality of antenna elements may then be mapped onto one CSI-RS port. For mmWave bands, although a number of antenna elements may be larger for a given form factor, a number of CSI-RS ports, that may correspond to the number of digitally precoded ports, may be limited due to hardware constraints (such as the feasibility to install a large number of ADCs/DACs at mmWave frequencies) as illustrated in FIG. 4. Then, one CSI-RS port may be mapped onto a large number of antenna elements that may be controlled by a bank of analog phase shifters 401. One CSI-RS port may then correspond to one sub-array which produces a narrow analog beam through analog beamforming 405. This analog beam may be configured to sweep across a wider range of angles (420) by varying the phase shifter bank across symbols or slots/subframes. The number of sub-arrays (equal to the number of RF chains) is same as the number of CSI-RS ports NCSI-PORT. A digital beamforming unit 410 performs a linear combination across NCSI-PORT analog beams to further increase a precoding gain. While analog beams are wideband (hence not frequency-selective), digital precoding may be varied across frequency sub-bands or resource blocks.

Although FIG. 4 illustrates one example antenna blocks or arrays 400, various changes may be made to FIG. 4. For example, various components in FIG. 4 could be combined, further subdivided, or omitted and additional components could be added according to particular needs.

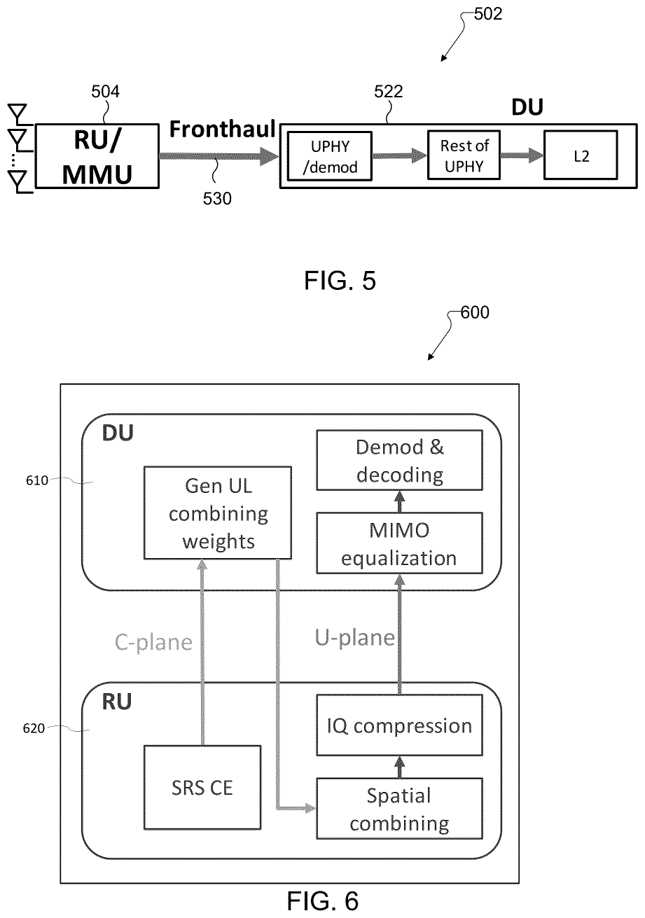

As previously described herein, base stations such as gNB 102 may be a collection of components rather than a single homogenous entity. This allows the base station to efficiently utilize physical space, share resources with other base stations and/or other network entities, virtualize certain components, etc. For example, a base station may be implemented as a distributed unit (DU) and a radio unit (RU). The RU may provide, for example, the functionality of transceivers 210a-210n and antennas 205a-205n, and the DU may provide the functionality of controller/processor 225 of gNB 102. The RU and the DU may be located at different physical locations, and may be coupled by a fronthaul network. An example of a base station comprising an RU and a DU is illustrated in FIG. 5.

FIG. 5 illustrates an example base station 502 split over a RU and a DU according to embodiments of the present disclosure. The embodiment of the base station 502 illustrated in FIG. 5 is for illustration only, and the gNBs 101, 102 and 103 of FIG. 1 could have the same or similar configuration. However, base stations come in a wide variety of configurations, and FIG. 5 does not limit the scope of this disclosure to any particular implementation of a base station.

As shown in FIG. 5, the base station 502 includes RU/massive MIMO unit (MMU) 504 and DU 522. RU/MMU 504 and DU 522 are coupled by fronthaul network 530. In the example of FIG. 5, RU/MMU 504 primarily performs functions similar to transceivers 210a-210n and antennas 205a-205n of gNB 102, and DU 522 primarily performs functions similar to controller/processor 225 of gNB 102. However, it should be understood than any base station functionality may be implemented in either of RU/MMU 504 or DU 522 according to particular needs. RU/MMU 504 and DU 522 may include additional components not described regarding gNB 102. For example, RU/MMU 504 and DU 522 may each include additional transceivers to support communication over fronthaul network 530, may each include additional processors to support various base station functionality, etc.

Although FIG. 5 illustrates one example of base station 502, various changes may be made to FIG. 5. For example, the base station 502 could include any number of each component shown in FIG. 5. Also, various components in FIG. 5 could be combined, further subdivided, or omitted and additional components could be added according to particular needs.

The O-RAN alliance publishes standards that govern protocols between a DU and an RU. O-RAN 7-2x category B is used for massive MIMO products, where antenna port signals are conveyed through the fronthaul on compressed data streams, rather than all the antenna port signals being transmitted over the fronthaul.

FIG. 6 illustrates an example 600 of base station signal flows according to embodiments of the present disclosure. The embodiment of base station signal flows illustrated in FIG. 6 is for illustration only. Different embodiments of base station signal flows could be used without departing from the scope of this disclosure.

FIG. 6 depicts block diagrams and signal flows within a DU 610, an RU 620, and across DU 610 and RU 620 according to embodiments of the present disclosure. In channel sounding, the sounding reference signal (SRS) is received and processed by RU 620. The channel state information (CSI) is obtained based on SRS channel estimation (CE) at RU 620. RU 620 sends the SRS CSI to DU 610 via control plane (C-plane) signaling. One application of the SRS CSI at DU 610 is to generate the uplink (UL) spatial combining weights. For UL MIMO reception, DU 610 generates UL spatial combining weights (this may also be called a spatial compression matrix), e.g., an 16×256 complex matrix (wherein 16 corresponds to the number of data streams [or layers] and 256 corresponds to the number of transceiver units at the RU) and sends the spatial combining weights to RU 620 via C-plane signaling complying with the Open Radio Access Network (O-RAN) protocol. The UL spatial combining weights are generated per sub-band, per data stream. Then, RU 620 applies the spatial compression on the 256 port received signals on each resource element (RE), by multiplying the UL spatial combining weights to the 256 port received signals. Then, these 16 data streams are compressed, e.g., using block floating compression and sent to DU 610 over an O-RAN user plane (U-plane).

The spatial compression is a lossy compression method, which may incur overall performance loss, in terms of receiver signal to interference plus noise ratio (SINR) that characterizes the channel demodulation/decoding performance.

In some embodiments, the spatial compression weights are computed based on SRS channel estimates. These embodiments can be used for both SU-MIMO and MU-MIMO. In one example, the spatial compression weights correspond to ZF matrix computed utilizing multi-user SRS channel estimates.

In some embodiments, the spatial compression weights are pre-configured. These embodiments are useful for those UEs for which SRS is not configured.

In some embodiments, DU 610 assigns multiple sets of spatial combining weights and RU 620 selects a set from the multiple sets to overcome the outdated effect of the pre-configured weights.

In some embodiments, the number of ports after spatial combining can be configured dynamically according to the number of UL layers, SINR intensity, etc.

In some embodiments, the same weights can be reused over a configured sub-band. Less sub-bandwidth benefits the granularity and receiver SINR; large sub-bandwidth benefits the fronthaul traffic and computational efficiency.

In an example of 256-to-16 spatial combining, assume the entire bandwidth is divided into 27 sub-bands (a 100 MHz bandwidth with 60 kHz sub-carrier, the sub-band in this example is 60 sub-carriers or 5 physical resource blocks [PRBs]). By using the traditional approach where DU 610 transfers all the weight matrices to RU 620, the total complex values required in the weights transfer is:
256*16 (matrix size)*2 (I/Q)*27 (sub-bands)*16 (bits per value)=3,538,944 bits.

In the C-plane protocol defined in the O-RAN Control, User, and Synchronization Plane (CUS-plane) Specification as Section Types (ST), there are 6 predefined STs in which ST1, ST3, and ST5 are determined for UL spatial combining configurations. For example, ST1 is for DL/UL radio channels requiring time or frequency offsets, ST3 is for channels requiring time or frequency offsets, and ST5 is for UE scheduling information. Commonly, ST1, ST3, and ST5 all contain the frame, sub-frame, slot, range of symbols, and range of PRBs with which the spatial combining will be applied. Beside the ST, section extensions (SEs) can be used to transfer extra information. For example, SE 1, SE 2, and SE 11 are determined for beamforming weights, beamforming attributes, and flexible beamforming weights transfer.

Although FIG. 6 illustrates an example 600 of base station signal flows, various changes may be made to FIG. 6. For example, various changes to the number of signals, the type of signals, etc. could be made according to particular needs.

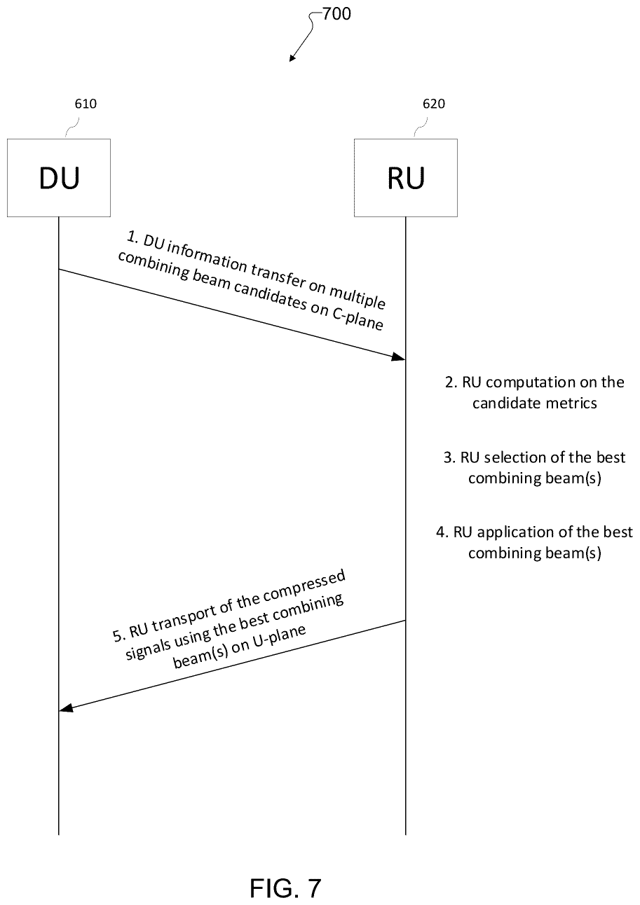

When the spatial compression weights previously discussed herein are pre-configured, the received signals strength sometimes weakens when the UE channel direction towards the BS is not aligned with the pre-configured spatial compression. An example method where an RU overcomes this issue by selecting from multiple combining beam candidates is illustrated in FIG. 7.

FIG. 7 illustrates a method 700 for UL MIMO data reception according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method 700 for UL MIMO data reception could be used without departing from the scope of this disclosure.

The example of FIG. 7 depicts operations for DU 610 and RU 620 for UL MIMO data reception according to embodiments of the present disclosure. At step 1, DU 610 transmits information on multiple combining beam candidates to RU 620 so that RU 620 can try these candidates for UL MIMO combining purposes. At step 2, RU 620 computes either received signal strength indicator (RSSI) or SINR metrics per candidate combining matrix. At step 3, RU 620 selects one or more combining weight matrices, which have the highest RSSI or SINR metrics. At step 4, RU 620 applies the selected combining weight matrix(ces) to the signals on e.g., 64 Rx antenna ports. Finally, at step 5, RU 620 transmits the e.g., 16 “compressed” signals to DU 610 over the U-plane.

In some embodiments, DU 610 may transfer extra information on measurement resources via the C-plane to facilitate the metric computation step. For example, DU 610 may transport information on RSSI, and/or signal and/or interference measurement resources to RU 620, which facilitates RU 620 to evaluate the candidate metrics in alternative ways. For example, SINR maybe regarded as more accurate metric than RSSI.

In some embodiments, the beam selection may be performed in a wide band or subband manner. For example, the determination or computation operation and weight application previously discussed herein may done in a wide-band or subband manner.

With regard to embodiments of the present disclosure, “beam” and “combining matrix” may be used interchangeably.

Although FIG. 7 illustrates one example of a method 700 for UL MIMO data reception, various changes may be made to FIG. 7. For example, while shown as a series of steps, various steps in FIG. 7 could overlap, occur in parallel, occur in a different order, or occur any number of times.

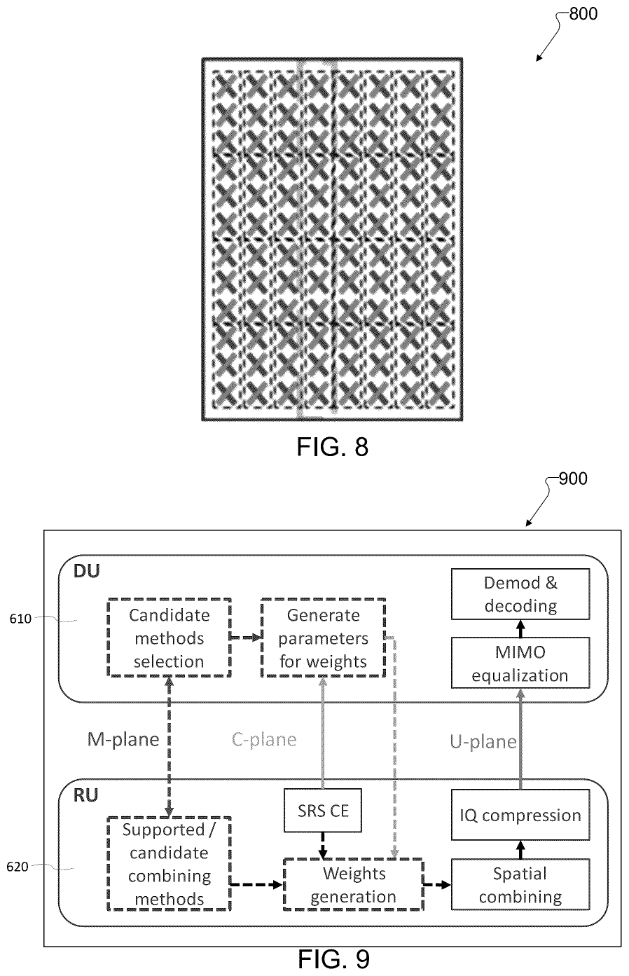

FIG. 8 illustrates an example of a massive MIMO antenna panel 800 according to embodiments of the present disclosure. The embodiment of a massive MIMO antenna panel illustrated in FIG. 8 is for illustration only. Different embodiments of a massive MIMO antenna panel could be used without departing from the scope of this disclosure.

In the example of FIG. 8 massive MIMO antenna panel 800 comprises 192 dual-polarized antenna elements placed on a 2D plane constructed according to embodiments of the present disclosure. The total number of elements on a vertical axis is 12, and the 12 elements are partitioned into 4 subarrays of 3 consecutive elements. On a horizontal axis, there are 16=(8×2 elements), accounting also for dual-polarized elements. There are 64 subarrays, and these 64 subarrays correspond to 64 digital ports or transceiver units. In some embodiments, a same spatial compression weight vector of length 4 is applied on every vertical axis comprising 4 subarrays.

In some embodiments, when denoting the 1×4 weight vector of as b₀, The 16×64 spatial compression weight vector can be constructed according to the following:

$${[ \begin{matrix}{b}_{0} & 0 & … & 0 \\ 0 & {b}_{0} & … & 0 \\ ⋮ & ⋮ & ⋱ & ⋮ \\ 0 & 0 & … & {b}_{0}\end{matrix} ]}_{16 \times 64}$$

This way, 64 signals are compressed to 16 ports, resulting in signals that are vertically compressed.

Although FIG. 8 illustrates an example of a massive MIMO antenna panel 800, various changes may be made to FIG. 8. For example, various changes to the number of elements, the arrangement of the elements, etc. could be made according to particular needs.

In some embodiments, an RU such as RU 620 is configured to try multiple candidate combining weight matrices (e.g., constructed from a set of 4 beam vectors {b₀, b₁, b₂, b₃}, wherein each beam vector is of dimension of 1×4) for UL MIMO, and decide and apply the best combining weights towards the received signals, and transport the combined signals to the DU on U-plane. This method may be referred to as smart combining beam selection at the RU.

In one embodiment, the RU makes use of RSSI to determine the best beam. Upon applying four candidate combining weight matrices, the RU obtains four different RSSI values corresponding to these four different combining weight matrices. The RU selects the beam (or combining matrix) that yields the highest RSSI among these four. Here, individual RSSI may be computed by an average of a sum of the magnitude squares of the 16 port complex numbers obtained after applying a specific spatial compression matrix on the 64-port received complex numbers on a group of resource elements.

Multiple methods may be used for the RU to determine beam selection granularity.

In one method, the RU selects and applies one combining weight matrix across the full bandwidth.

In another method, the RU selects and applies one combining weight matrix for all the REs of the corresponding U-plane message.

In one method, the RU selects and applies one combining weight matrix per subband, wherein a subband may comprise a number of PRBs (physical resource blocks, which comprises 12 resource elements on the frequency domain).

In another method, the RU selects and applies one combining weight matrix per group of REs that comprises all the REs for the U-plane message to transport the IQ samples, wherein the group of REs correspond to a subband.

In some embodiments, a DU such as DU 610 transports information on beam selection granularity over the C-plane or management plane (M-plane). In one embodiment, beam selection granularity information is specified in terms of a number of consecutive PRBs for which a same selected beam shall be applied. If IQ samples of multiple OFDM symbol resources are transported on a single U-plane, the same beam is applied across the OFDM symbols for each group of consecutive PRBs as configured by the corresponding C-plane message.

In some embodiments, the RU autonomously selects the beam selection granularity.

Multiple methods may be used to configure an RU for conducting smart combining beam selection.

In one embodiment, the DU configures necessary information to facilitate the smart combining beam selection.

In one embodiment, the DU transports IQ samples corresponding to e.g., four candidate combining weight matrices of size 16×64 each via C-plane, e.g., section type 1 or its extension. Then, the RU applies the smart combining beam selection over these four combining weight matrices.

In another embodiment, the DU transports IQ samples corresponding to e.g., 10 candidate combining weight matrices of size 16×64 each via M-plane, wherein each matrix is one-to-one mapped to a beam ID. These 10 candidate matrices may be referred to as a beam book in some embodiments. Then, upon UL MIMO reception, the DU transports a C-plane message conveying selected e.g., 4 beam IDs, along with other UL MIMO scheduling information that is necessary for the RU to transport corresponding U-plane message(s) to DU. Then, the RU applies the smart combining beam selection over four candidate combining weight matrices identified by these 4 beam IDs, i.e., these four candidate matrices are selected from the pre-configured beam book from the M-plane.

In another embodiment, the RU has a pre-configured beam book, and the RU autonomously selects a subset of combining matrices from the pre-configured beam book, to conduct smart combining beam selection operation.

Multiple methods may be used for the RU to select REs for computing the metrics across the candidate matrices to choose a combining matrix.

In one embodiment, the DU transports information on a set of REs to measure the RSSI, over the C-plane or M-plane. The resources that are used for RSSI measurement may be referred to as an RSSI measurement resource (RMR). The DU may select a set of REs as an RMR that corresponds to PUSCH resource elements.

In one embodiment, the DU transports information on a set of REs to measure the signal power, over the C-plane or M-plane. The resources that are used for signal power measurement may be referred to as an signal measurement resource (SMR). The DU may select a set of REs as an SMR that corresponds to UL DMRS resource elements. When an SMR is configured, the RU computes signal powers (SPs) across these different candidate combining matrices, and selects a best combining matrix that gives the highest SP, and uses the best combining matrix.

In some embodiments, individual SP is computed by an average of a sum of the magnitude squares of the 16 port complex numbers obtained after applying a specific spatial compression matrix on the 64-port received complex numbers on a subset of SMRs.

In some embodiments, the information on the set of REs is conveyed via a 12-bit bitmap signaling, which is regards to 12 positions (or REs or subcarriers) comprising each PRB. In this case, the RU is configured to use a subset of those signals received on the positions with state “1” is indicated across all the PRBs.

In another embodiment, the RU autonomously selects a set of REs based on its own judgement and constraints, e.g., computational budget. In one embodiment, the RU selects one or more REs per subband, comprising a group of consecutive PRBs. In another embodiment, the RU selects one or more REs across the full BW or across all the REs for which the U-plane message will carry IQ samples.

In some embodiments, the DU transports information on a set of REs to measure interference, over the C-plane or M-plane. The resources that are used for interference measurement may be referred to as an interference measurement resource (IMR). The DU may select a set of REs as an IMR that corresponds to those resource elements on which no signals are mapped. Upon configured with IMR, the RU applies e.g., 4 candidate combining matrices over the IMR and obtains 4 interference power values (IPs).

When IMR is configured, in some embodiments, the RU alternatively uses SINR as a metric for selecting one combining matrix. In these embodiments, the RU first computes at least two of RSSI, IP and SP per combining matrix, and uses them to compute signal to interference ration (SIR) or SINR per combining matrix. Then, the RU selects the best combining matrix that gives the highest SIR or SINR and uses the matrix to generate IQ samples to transport over the U-plane.

In some embodiments, the RU computes SINR as (RSSI−IP)/(IP).

In some embodiments, the RU computes SINR as (SP)/(IP).

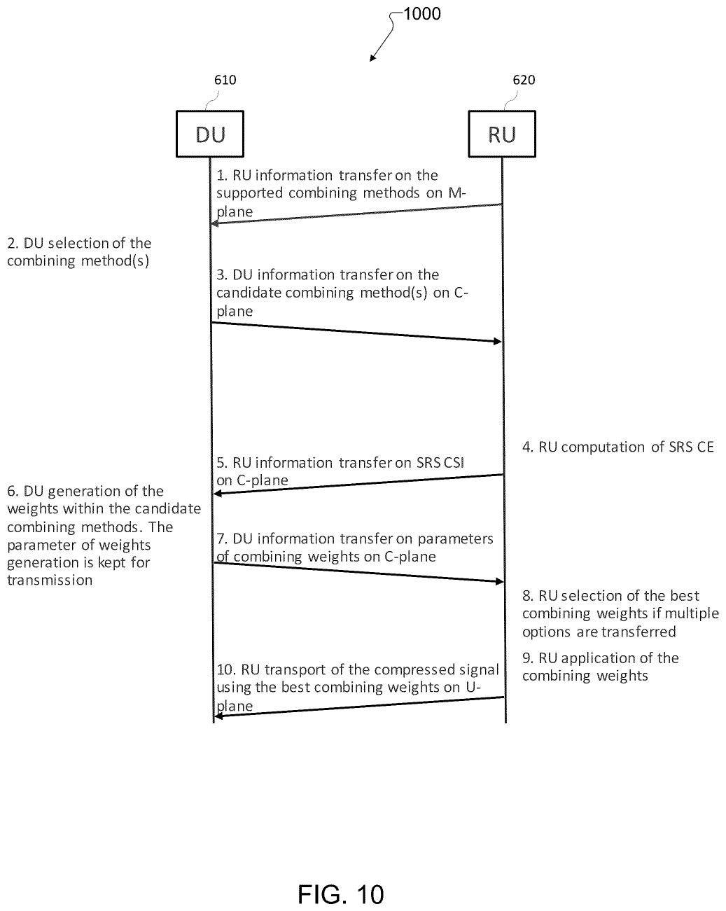

The UL spatial combining discussed previously herein reduces the U-plane fronthaul data traffic efficiently. However, the RU requires the spatial combining weights transferred from the DU. Transferring the weights on C-plane causes a heavy traffic problem for the fronthaul. The fronthaul traffic problem becomes severe when the RU has a massive or extremely large number of antennas or the number of the ports after spatial combining is large, which increases the number of values inside the weight matrix. The fronthaul traffic problem also becomes severe when the DU assigns multiple sets of weights and from which the RU can select or dedicated weights are used per the sub-band and the number of sub-bands is large, which increases the number of weight matrices to be transferred. An example communications method that overcomes this issue is illustrated in FIG. 9 and FIG. 10.

FIG. 9 illustrates an example 900 of base station signal flows according to embodiments of the present disclosure. The embodiment of base station signal flows illustrated in FIG. 9 is for illustration only. Different embodiments of base station signal flows could be used without departing from the scope of this disclosure.

FIG. 9 depicts block diagrams and signal flows within DU 610 and RU620 and across DU 610 and RU 620 according to some embodiments of the current disclosure. The blocks and arrows with dashed lines are new with respect to FIG. 6. The most significant difference with the example of FIG. 6 is transferring the parameters of the spatial combining weights from DU 610 to RU 620, rather than transferring the spatial combining weights.

According to an embodiment, the traffic in the C-plane is reduced. RU 620 generates the spatial combining weights according to: 1) the spatial combining methods, 2) the received parameters, 3) the codebook, SRS CSI, etc. In some embodiment, the spatial combining methods are shared in the handshaking phase through the management plane (M-plane) between DU 610 and RU 620. To achieve the cooperation between the two devices, information is transferred. For instance, in the initial hand-shake between RU 620 and DU 610, RU 620 may report the UL (uplink) combing related settings, for example the supported spatial combining methods, to DU 610 via the M-plane. DU 610 configures the selected spatial combining method for RU 520 via the M-plane or the C-plane.

Although FIG. 9 illustrates an example 900 of base station signal flows, various changes may be made to FIG. 9. For example, various changes to the number of signals, the type of signals, etc. could be made according to particular needs.

FIG. 10 illustrates a method 1000 for UL MIMO data reception according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method 1000 for UL MIMO data reception could be used without departing from the scope of this disclosure.

The example of FIG. 10 depicts operations for DU 610 and RU 620 for UL MIMO data reception according to embodiments of the present disclosure. At step 1, RU 620 transports information on the one or multiple supported method(s) of the UL spatial combining to DU 610. At step 2, DU 610 down selects one or multiple appropriate methods as candidate spatial combining method(s) so that RU 620 can use in the UL spatial combining. The down selection may according to the higher layer settings, e.g., the availability at DU 610. At step 3, DU 610 transports information of the candidate spatial combining method to RU 620. RU 620 can only apply the down selected candidate spatial combining method(s). In this way, the candidates can be synchronized at both DU 610 and RU 620. At step 4, RU 620 performs the SRS CE and keeps the SRS CSI in memory. At step 5, RU 620 transfers the SRS CSI to DU 610. At step 6, DU 610 generates the parameters of assembling the spatial combining weight matrix(ces) according to the selected spatial combining method(s) and the SRS CSI. At step 7, DU 610 transports (e.g., via a control message) information on the spatial combining method(s) and parameters of spatial combining weight matrix(ces) to RU 620. At step 8, RU 620 selects the spatial combining weight matrix(ces) which have the highest metrics, if multiple candidates exist. At step 9, RU 620 applies the selected spatial combining weight matrix(ces) to the signals on e.g., 256 Rx antenna ports. Finally, at step 10, RU 620 transports the e.g., 16 “compressed” signals to DU 610 over the U-plane.

In some embodiments, at step 3, DU 610 may transfer the codebook required with the candidate spatial combining methods. For example, DU 610 may transport information on the codebooks of spatial combining weights if codebook required methods are selected by DU 610.

In some embodiments, at step 3, when multiple candidates of the weight are transferred, the DU may transfer extra information on measurement resources via C-plane to facilitate the metric computation step. For example, DU 610 may transport information on RSSI, and/or signal and/or interference measurement resources to RU 620, which facilitates RU 620 to “compute” the candidate metrics in alternative ways. For instance, SINR maybe regarded as more accurate metric than RSSI.

In some embodiments, at step 7, the spatial combining may be performed in a wide band or sub-band manner. For example, when using the wide-band manner, RU 620 may generate one weight matrix applied to the entire band, and DU 610 may transfer the parameters for that weight matrix. Alternatively, when using the sub-band manner, RU 620 may generate one weight matrix applied to each sub-band, and DU 610 may transfer the parameters for the weight matrix in each sub-band.

Although FIG. 10 illustrates one example of a method 1000 for UL MIMO data reception, various changes may be made to FIG. 10. For example, while shown as a series of steps, various steps in FIG. 10 could overlap, occur in parallel, occur in a different order, or occur any number of times.

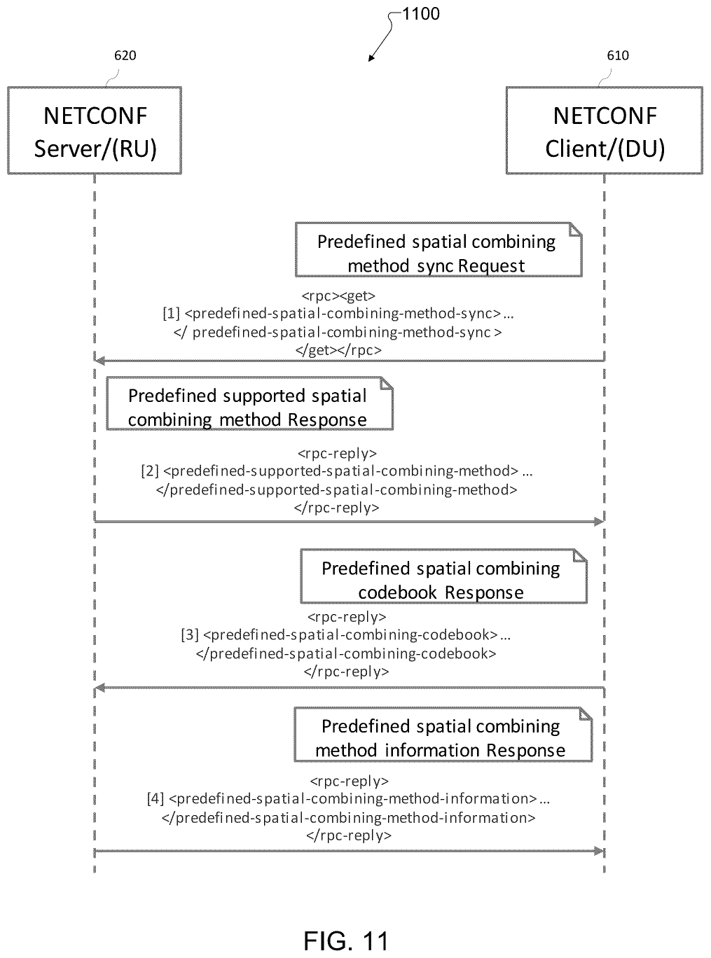

FIG. 11 illustrates an example of a method 1100 of M-plane signaling according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method 1100 of M-plane signaling could be used without departing from the scope of this disclosure.

The example of FIG. 11 depicts operations for DU 610 and RU 620 M-plane signaling according to embodiments of the present disclosure. At step 1, DU 610 sends a request of synchronizing the spatial combining methods to RU 620. At step 2, RU 620 replies to the request by sending the supported spatial combining methods through a predefined format. At step 3, DU 610 receives the reply and down selects the options of the spatial combining methods supported by RU 620. In the case that the spatial combining methods require additional information, such as a codebook of the spatial combining weights, DU 610 transfers the required information to the RU in at step 3. At step 4, RU 620 transfers an acknowledgement to DU 610.

Although FIG. 11 illustrates one example of a method 1100 of M-plane signaling, various changes may be made to FIG. 11. For example, while shown as a series of steps, various steps in FIG. 11 could overlap, occur in parallel, occur in a different order, or occur any number of times.

In one embodiment the information transfers are achieved in the C-plane for dedicated UL/DL transmissions and configurations. For example, RU 620 may transfer the SRS CSI as shown in step 5 of FIG. 10, which has existing C-plane signaling. DU 610 may transfer the parameters of the spatial combining weights as shown in step 7 of FIG. 10 as further described herein. After applying the spatial combining, RU 620 transfers the PUSCH to DU 610 through U-plane as shown in step 10 of FIG. 10 using existing U-plane signaling.

With respect to step 7 of FIG. 10, ST5 (Section Type 5) is defined/existed in the ORAN specification. ST5 can be used to transfer the frame, subframe, slot and PRB range of the data to which the spatial combining will be applied.
In the field “ueId” in the ST5, all UE layers in the same MU-MIMO user group shall be described in the same ST message. Thus the “ueId” shall be a base UE ID with least significant bits (LSB) as zeros. The spatial combining configurations for all the UE layers are in the same section in ST5.
The number of the option can be indicated in the field “numberOfsections” in the header. If “numberOfsections=1”, the it indicates the DU transfers one option of the spatial combining weight, and the RU generates and applies accordingly; If the “numberOfsections” is larger than one, it indicates the DU transfers multiples options of the spatial combining weights and let the RU to choose. If the RU is not support choosing from the options, the first option will be applied by default.

The detailed parameters of the spatial combining weights are transferred in the section extension (SE) attached to each section in ST5. The format of the SE depends on the spatial combining method. Examples of the signaling of digital port grouping information in SE which may be used in some of the spatial combining methods are described herein. Some embodiments of the SE used in a variety of cases are described herein.

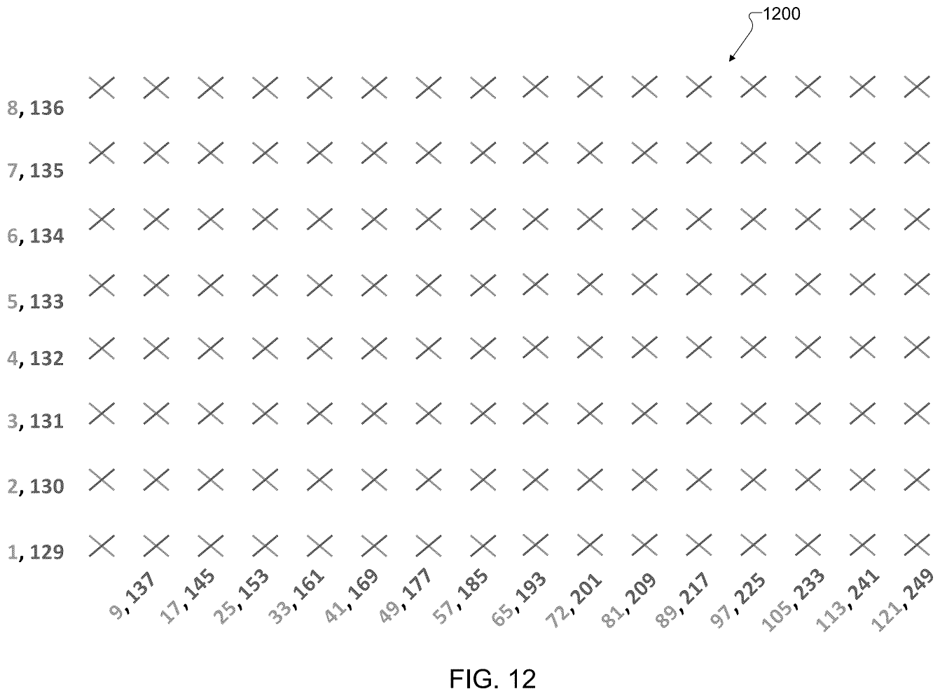

FIG. 12 illustrates an example of an extremely massive MIMO antenna panel 1200 according to embodiments of the present disclosure. The embodiment of an extremely massive MIMO antenna panel illustrated in FIG. 12 is for illustration only. Different embodiments of an extremely massive MIMO antenna panel could be used without departing from the scope of this disclosure.

In the example of FIG. 12 extremely massive MIMO antenna panel 1200, comprises 256 dual-polarized digital ports placed on a 2D plane constructed according to some embodiments of the present disclosure. On the horizontal axis, there are 16 ports per polarization; on the vertical axis, there are 8 ports per polarization. The digital ports with the first polarization have a −45 degree slope, and index from 1 to 128. The digital ports with the second polarization have 45 degree slope, and index from 129 to 256. In the example of FIG. 12, the digital ports correspond to an array [Nᵥ×Nₕ×Nₚ]=[8×16×2] in vertical, horizontal, and polarization respectively.

In an embodiment, e.g., a 256-to-16 spatial combining, can be achieved by 16 of 256-to-1 spatial combining with 256 spatial combining weights, which will be multiplied to the 256 digital ports correspondingly and take the summation as the combining result. The DU shall config the RU to generate 16 of the 256-to-1 spatial combining weights to achieve the spatial combining. The SE 17 can be used to transfer the port mask for the 16 of 256-to-1 spatial combining weights. SE 17 is determined to transfer antenna mask and support up to 64 antennas in the contiguous 64 bits. True or False of each bit representing if the port is selected or not. To support 256 ports, the SE 17 can be extended to use contiguous 256 bits instead of 64.

In some embodiments, the computational complexity or memory utilization of 256-to-1 combing cannot be supported by the DU or RU. To reduce the complexity and memory utilization, the [Nᵥ×Nₕ×Nₚ] digital ports can be divided into several port-groups, and the DU will determine the spatial combining weights based on the port-groups.

Although FIG. 12 illustrates an example of an extremely massive MIMO antenna panel 1200, various changes may be made to FIG. 12. For example, various changes to the number of elements, the arrangement of the elements, etc. could be made according to particular needs.

In one embodiment, the digital ports are divided in to Ng groups. The dimension of a port-group is defined as the number of vertical, horizontal, and polarization digital ports inside that port-group. For example, the dimension for the i^{th} port-group is [Nᵥⁱ×Nₕⁱ×Nₚⁱ], which are the dimensions in vertical, horizontal, and polarization, respectively.

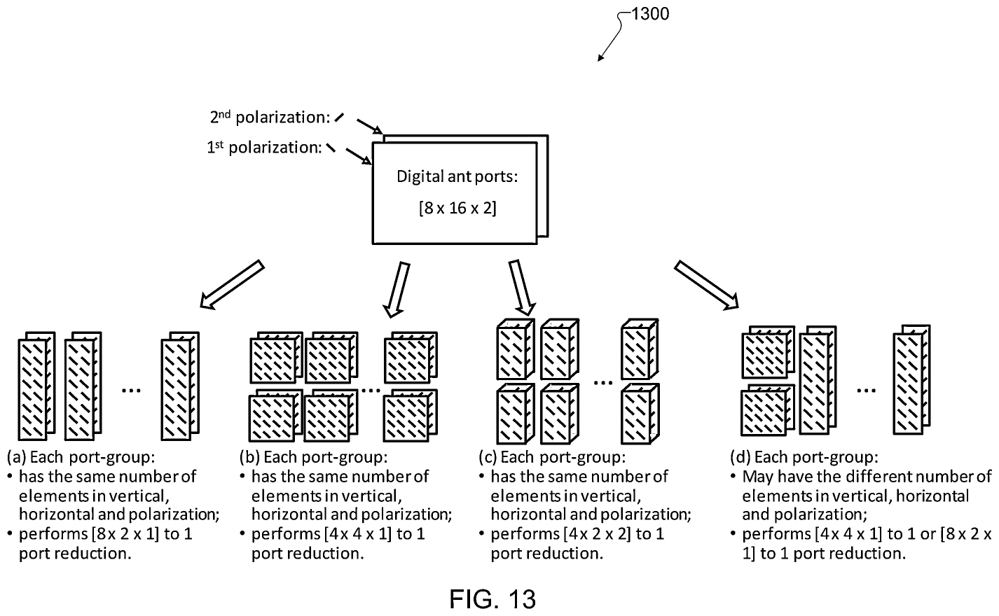

In terms of the dimension of each port-group, the dimension can be same or different, as illustrated by the examples in FIG. 13.

FIG. 13 illustrates an example 1300 of port group dimensions according to embodiments of the present disclosure. The examples of port group dimensions illustrated in FIG. 13 are for illustration only. Different embodiments of port group dimensions could be used without departing from the scope of this disclosure.

In the example of FIG. 13, the full digital ports have [Nᵥ×Nₕ×Nₚ]=[8×16×2] ports in vertical, horizontal, and polarization respectively. The digital ports with two polarizations are denoted as short line segments in −45 degree or +45 degree. In each example of FIG. 13 (a-d), each port-group is represented in a rectangular or a cuboid. The port-groups may share the same dimension as in FIG. 13 (a-c), or different dimensions as in FIG. 13 (d). The port-groups may contain the digital ports only having the same polarization as shown in FIGURE (a, b, and d), or may contain two polarizations as in FIG. 13 (c).

Although FIG. 13 illustrates an example 1300 of port group dimensions, various changes may be made to FIG. 13. For example, various changes to the number of ports, the arrangement of the port groups, etc. could be made according to particular needs.

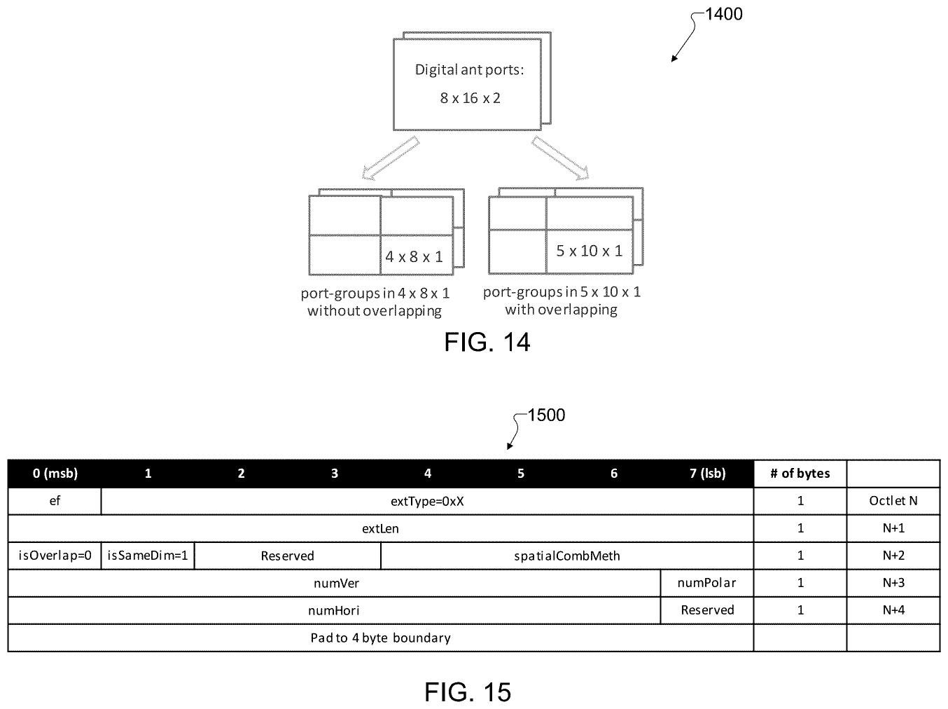

In terms of the relative location of the port-groups, the port-groups can be over-lapped or isolated, as shown in the examples in FIG. 14.

FIG. 14 illustrates an example 1400 of port group dimensions according to embodiments of the present disclosure. The examples of port group dimensions illustrated in FIG. 14 are for illustration only. Different embodiments of port group dimensions could be used without departing from the scope of this disclosure.

In the example of FIG. 14, for simplicity, the short line segments representing the two polarizations as illustrated in FIG. 13 are absent. In an embodiment where the RU supports a variety of port-group divisions, the DU can configure the port-group divisions as necessary parameters that will be transferred to the RU such as in step 3 in FIG. 10, or dynamically configure the port-group division such as in step 7 in FIG. 10.

Although FIG. 14 illustrates an example 1400 of port group dimensions, various changes may be made to FIG. 14. For example, various changes to the number of ports, the arrangement of the port groups, etc. could be made according to particular needs.

One possible way of signaling the port-group division is through SE16 defined in the ORAN CUS-plane spec. SE16 supports transferring antenna mapping for UE channel info based UL beamforming. One or multiple (up to 16) “antMask” field(s) exist in SE16. Each “antMask” contains 64 bits indicating on/off of up to 64 ports in a group. To support 256 digital ports in the example, the SE16 can be extended as 256 bit per “antMask”, i.e., 256*16=4096 for a 16 port-group division. The efficiency is limited. To efficiently signal the port-group division in the C-plane, a new section extension type is described below.

Except the required field in SE such as “ef”, “extType”, and “extLen”, the first two bits in the Octet after “extLen” are used to indicate:
Field “isOverlap”: 1 bit, indicates if the port-group division has overlapping.)
   If False, the only the dimensions are signaled per port-group.
   If True, the dimensions and the least index of the port-group are signaled.
Field “isSameDim”: 1 bit, indicates if the port-groups have the same dimension.
   If True, may use two octets to transfer the dimensions of all the port-group.
   IF False, the dimensions of K port-groups may be transferred in the current SE. For each port-group, 2 octets may be used.
Field “spatialCombMeth”: 4 bits to transfer the index of the spatial combining method in some embodiments.
   “spatialCombMeth” is optionally supported by the DU and RU. If supported, by default, “spatialCombMeth”=0000b means the port reduction method is inferred from the section type and section extension types.
   The DU and RU may exchange specific port reduction method(s) through M-plane and identified by “spatialCombMeth”, where each port reduction method is defined for all the port-groups (share the same configuration or independently configured by the followed section extension types).
   When using the SE-X, the DU indicates the port reduction method in “spatialCombMeth” field.

An example of an embodiment is described with respect to two cases (field “isOverlap” is False or True) below.

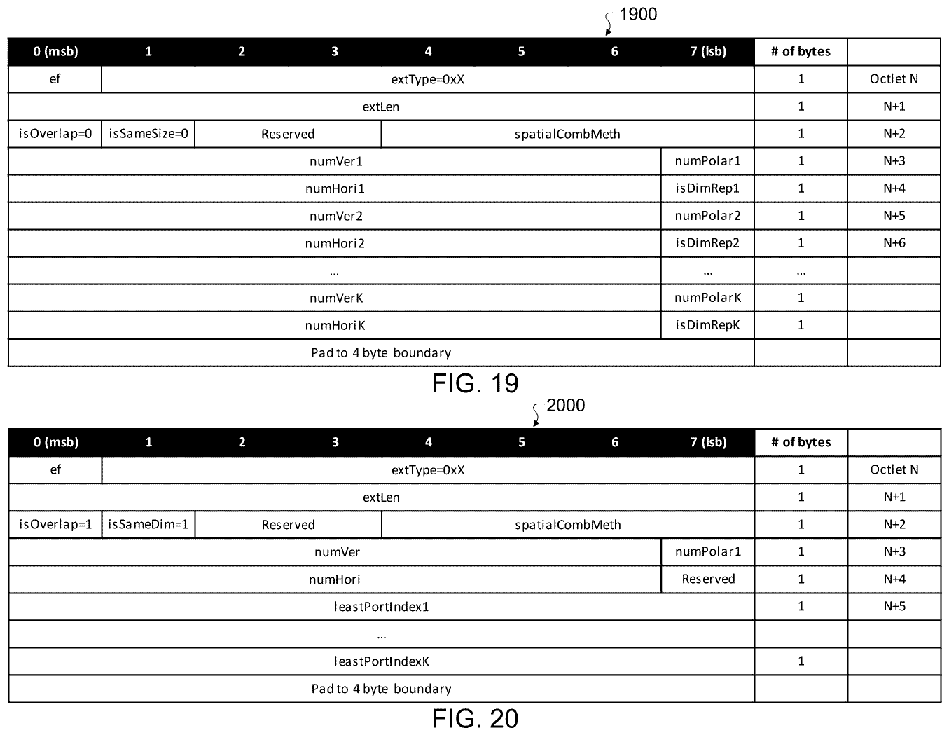

If the port-group division is in a non-overlapping manner (i.e., the left-bottom element in each port group as shown in FIG. 13), one embodiment of port-group division signaling is shown in FIG. 15, FIG. 18, and FIG. 19 for port-groups having the same and different dimensions (the dimension means [Nᵥⁱ, Nₕⁱ, Nₚⁱ]), respectively.

When the port-groups have the same dimension, only signaling the number of ports in vertical, horizontal, and polarizations as in FIG. 15.

FIG. 15 illustrates an example 1500 of a section extension according to embodiments of the present disclosure. The example of a section extension illustrated in FIG. 15 is for illustration only. Different embodiments of a section extension could be used without departing from the scope of this disclosure.

In the example of FIG. 15 the LSB after field “numHori” is reserved. The fields are defined as follows:
Field “numVer”: 7 bits are used to represent the number of ports in vertical dimension of the port-groups. The value of “numVer” can vary from 0 to 127. Zero can be specially defined 128.
Field “numPolar”: 1 bit is used to represent the number of polarizations of the port-groups.
   False: using 2 polarization, since 0 (0b) can be seen as 2 (10b). (0b) and (10b) are the same in LSB.
   True: using 1 polarization.
Field “numHori”: 7 bits are used to represent the number of ports in horizontal dimension of the port-groups. The value of “numHori” can vary from 0 to 127. Zero can be specially defined 128.

Although FIG. 15 illustrates an example 1500 of a section extension type, various changes may be made to FIG. 15. For example, various changes to the number of fields, the arrangement of the fields, etc. could be made according to particular needs.

When the ports have different dimensions, the dimension of each port groups shall be signaled:

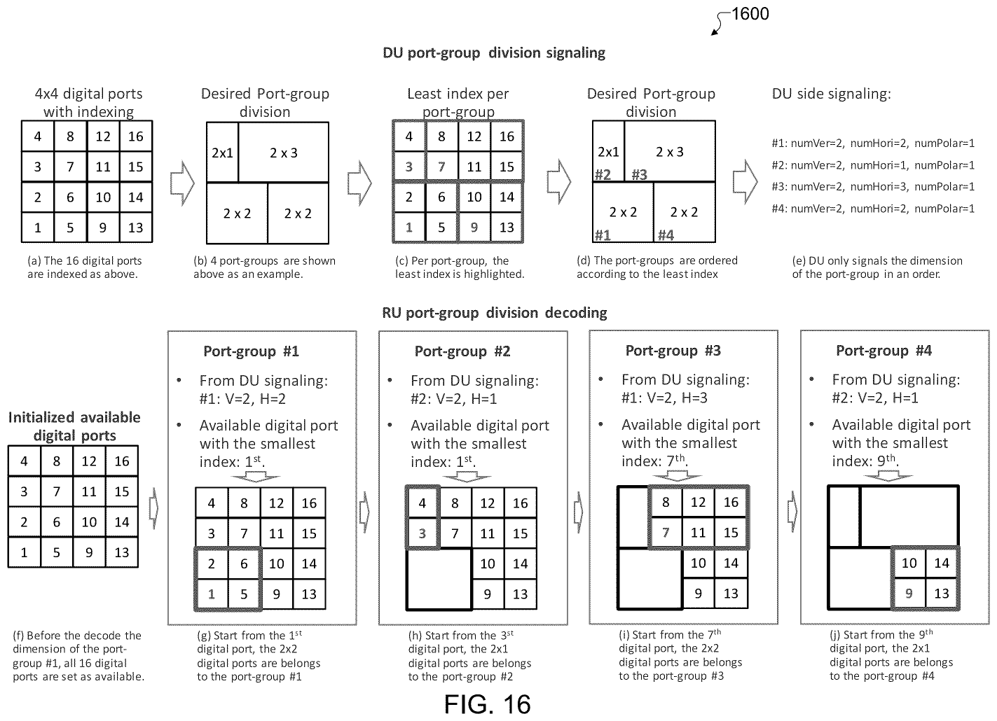

In one embodiment, when the ports have different dimensions, the dimensions of each ant-group are signaled in a queue, in which the port-groups are sorted by the least port index within the port-group. The lease port index is defined as the minimum index among a port-group. An example is illustrated in to FIG. 16. Since the port-groups are not overlapping, the least port index is unique among the port-groups.

FIG. 16 illustrates an example 1600 of port group division signaling and decoding according to embodiments of the present disclosure. The example of port group division signaling and decoding illustrated in FIG. 16 is for illustration only. Different embodiments of port group division signaling and decoding could be used without departing from the scope of this disclosure.

FIG. 16 depicts an example of a simple case with only 16 digital ports. The dimensions of the digital ports are 4 in vertical, 4 in horizontal, and 1 in polarization. At the DU side:
The index of each digital port is shown in the FIG. 16 (a).
As an example, the desired port-group division at the DU is shown in FIG. 16 (b).
In each port-group, the DU can obtain the least index as shown in FIG. 16(c).
By sort the least index of each port-group in a ascend manner, the order of the four port-groups are shown in FIG. 16 (d).
In the signaling, the DU may signal the dimension of the port-groups as FIG. 16 (f). The port-group division may transfer inside the SE X to the RU.

At the RU side:
The RU may initialize all the 16 digital ports as available.
The dimension of the port-group #1 may firstly obtained from the SE X, which is 2×2.
   The RU may take the least index from the available index, which is the 1^{st} digital port.
   The RU may assign the 2×2 port-group, whose left-bottom corner is the lest index, i.e., the 1^{st} digital port.
   Within the port-group #1, the digital ports may set as unavailable for the rest of port-groups.
The dimension of the port-group #2 may next obtained from the SE X, which is 2×1.
   The RU may take the least index from the available index, which is the 3^{rd} digital port.
   The RU may assign the 2×1 port-group, whose left-bottom corner is the lest index, i.e., the 3^{rd} digital port.
   Within the port-group #2, the digital ports may set as unavailable for the rest of port-groups.
The dimension of the port-group #3 may next obtained from the SE X, which is 2×3.
   The RU may take the least index from the available index, which is the 7th digital port.
   The RU may assign the 2×3 port-group, whose left-bottom corner is the lest index, i.e., the 7th digital port.
   Within the port-group #3, the digital ports may set as unavailable for the rest of port-groups.
The dimension of the port-group #4 may next obtained from the SE X, which is 2×2.
   The RU may take the least index from the available index, which is the 9th digital port.
   The RU may assign the 2×3 port-group, whose left-bottom corner is the lest index, i.e., the 9th digital port.
   Within the port-group #3, the digital ports may set as unavailable for the rest of port-groups (this is optional since the #4 is the last port-group.)

In this way, the RU may uniquely obtain the port-group division the same to the desired port-group division in the DU.

Although FIG. 16 illustrates an example 1600 of port group division signaling and decoding, various changes may be made to FIG. 16. For example, various changes to the number of ports, the arrangement of the port groups, etc. could be made according to particular needs.

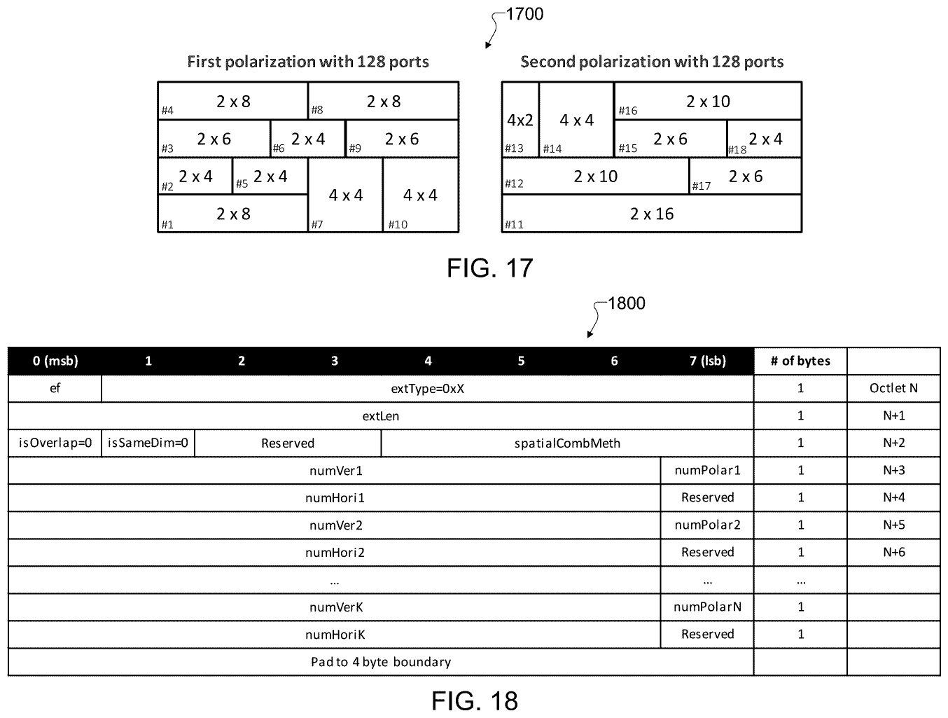

FIG. 17 illustrates an example 1700 of port-group division and the order of a port-group with 256 digital ports according to embodiments of the present disclosure. The example of port group division illustrated in FIG. 17 is for illustration only. Different embodiments of port group division could be used without departing from the scope of this disclosure.

In the example of FIG. 17, the index of the digital ports is shown in FIG. 16. The #1 port-group lies on the left bottom corner. The least port index of #port group is 1. The #2 port-group has the least port index as 3, which is larger than the least port index of the #1 port-group and less than the other port-groups. In this way, all the 18 port-groups are ordered as shown in FIG. 17.

In this way, the location of the port-groups within the entire digital port can be omitted. The RU can uniquely calculate the location of each port group one-by-one, as shown in the following example using the port-group division as shown in FIG. 17:
Before calculating the location of the port-groups, the 256 digital ports are available. The indexes of the digital ports are from 1^{st} to 256^{th}.
Port-group #1:
   Dimension: the RU is indicated that the dimension of the port-group #1 is 2×8×1.
   The minimum available digital port is the 1^{st}.
   Take the origin as the 1^{st} digital port, digital ports in range 2×8×1 are belongs to the port-group #1.
   Set the digital ports belongs to the port-group #1 as unavailable. Then, the minimum available digital port is the 3rd.
Port-group #2:
   Dimension: the RU is indicated that the dimension of the port-group #1 is 2×4×1.
   The minimum available digital port is the 3^{rd}.
   Take the origin as the 1^{st} digital port, digital ports in range 2×4×1 are belongs to the port-group #2.
   Set the digital ports belongs to the port-group #2 as unavailable. Then, the minimum available digital port is the 5^{th}.
Port-group #3:
   Dimension: the RU is indicated that the dimension of the port-group #1 is 2×6×1.
   The minimum available digital port is the 5^{th}.
   Take the origin as the 1^{st} digital port, digital ports in range 2×6×1 are belongs to the port-group #3.
   Set the digital ports belongs to the port-group #3 as unavailable. Then, the minimum available digital port is the 7^{th}.
Port-group #4:
   Dimension: the RU is indicated that the dimension of the port-group #1 is 2×8×1.
      The minimum available digital port is the 7^{th}.
      Take the origin as the 1^{st} digital port, digital ports in range 2×8×1 are belongs to the port-group #4.
   Set the digital ports belongs to the port-group #4 as unavailable. Then, the minimum available digital port is the 35^{th}.
Port-group #5:
   Dimension: the RU is indicated that the dimension of the port-group #1 is 2×4×1.
   The minimum available digital port is the 35^{th}.
   Take the origin as the 1^{st} digital port, digital ports in range 2×4×1 are belongs to the port-group #5.
   Set the digital ports belongs to the port-group #5 as unavailable. Then, the minimum available digital port is the 53^{rd}.
The rest port-groups are configured accordingly.

Although FIG. 17 illustrates an example 1700 of port group division, various changes may be made to FIG. 17. For example, various changes to the number of ports, the arrangement of the port groups, etc. could be made according to particular needs.

Two alternatives for signaling are described below with respect to claims 18 and 19. In terms of the dimension transfer, the “numVer”, “numPolar”, and “numHori” are kept the same as in FIG. 15.

FIG. 18 illustrates an example 1800 of a section extension according to embodiments of the present disclosure. The example of a section extension illustrated in FIG. 18 is for illustration only. Different embodiments of a section extension could be used without departing from the scope of this disclosure.

Signaling all the dimensions of the port-groups as shown in FIG. 18. The “numVer”, “numPolar”, and “numHori” indicate the number of ports in vertical, polarization, and horizontal of each port-group. The port-groups can be ordered in the logic as shown in FIG. 17.

Although FIG. 18 illustrates an example 1800 of a section extension, various changes may be made to FIG. 18. For example, various changes to the number of fields, the arrangement of the fields, etc. could be made according to particular needs.

FIG. 19 illustrates an example 1900 of a section extension according to embodiments of the present disclosure. The example of a section extension illustrated in FIG. 19 is for illustration only. Different embodiments of a section extension could be used without departing from the scope of this disclosure.

FIG. 19 differs from FIG. 18 in that the field of the reserved bit is assigned as “isDimRep”:
Field “isDimRep”: 1 bit to indicate if the next port-group has the same dimension.
   If False, the dimension of the next port-group will be signaled.
   If True, the dimension next port-group will not be omitted and will signal the second from the next port-group (if exist).

In this way, the length of the SE will be reduced if exist at least two adjacent port-groups have the same dimension. The “numVer”, “numPolar”, and “numHori” indicate the number of ports in vertical, polarization, and horizontal of each port-group. The port-groups can be ordered in the logic as shown in FIG. 17.

Although FIG. 19 illustrates an example 1900 of a section extension, various changes may be made to FIG. 19. For example, various changes to the number of fields, the arrangement of the fields, etc. could be made according to particular needs.

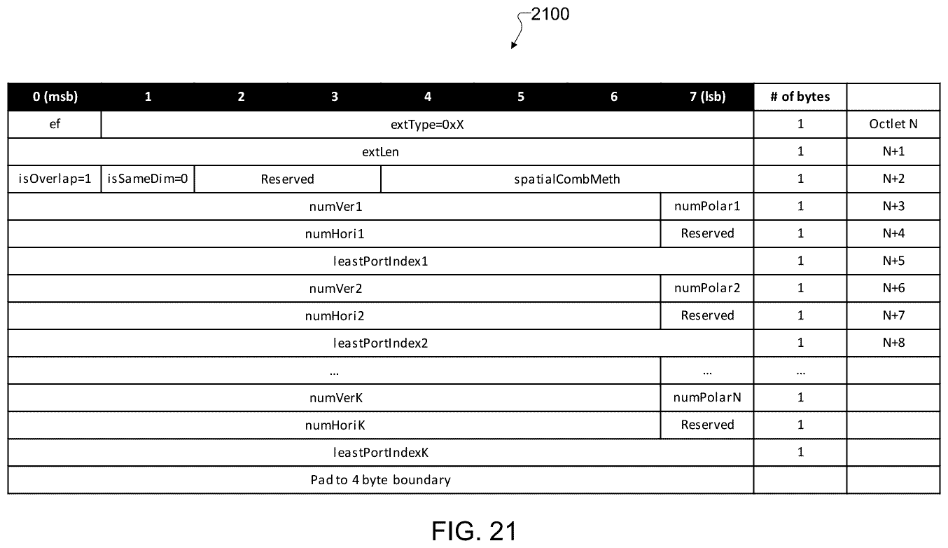

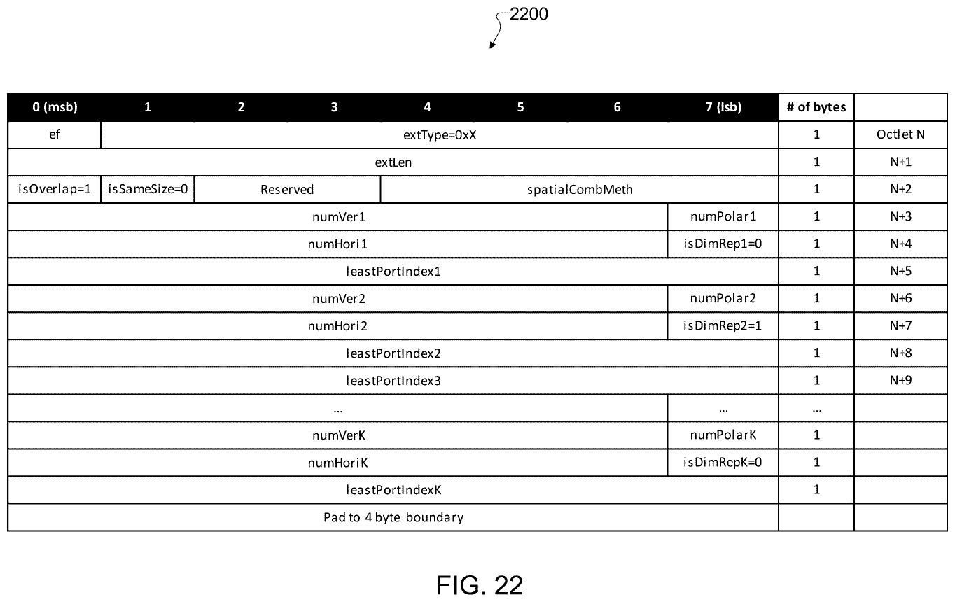

FIG. 20, FIG. 21, and FIG. 22 illustrate embodiments of port-group division signaling where the port-group division is overlapping (i.e., the left-bottom element in each port group as shown in FIG. 17) for port-groups having the same and different dimensions (dimension means [Nvi, Nhi, Npi]), respectively.

If the port-group division is in an overlapping manner (i.e., the left-bottom element in each port group as shown in FIG. 13), one embodiment of the port-group division signaling is shown in FIG. 20, FIG. 21, and FIG. 22 for port-groups having the same and different dimension (the dimension means [Nᵥⁱ, Nₕⁱ, Nₚⁱ]), respectively.

FIG. 20 illustrates an example 2000 of a section extension according to embodiments of the present disclosure. The example of a section extension illustrated in FIG. 20 is for illustration only. Different embodiments of a section extension could be used without departing from the scope of this disclosure.

When the port-groups have the same dimension, signaling is used for the number of ports in vertical, horizontal, polarizations, and the least index of each port-groups as in FIG. 20. The signaling of the dimension of the port-group is the same as FIG. 14. The least index is signaled in:
Field “leastPortIndex”: in 8 bits and the value can vary from 0 to 255. Zero can be specially defined 256.

Although FIG. 20 illustrates an example 2000 of a section extension, various changes may be made to FIG. 20. For example, various changes to the number of fields, the arrangement of the fields, etc. could be made according to particular needs.

When the port-groups have different dimensions, both the dimension and the least index of each port-group is signaled. Two alternatives are illustrated, similar as shown regarding FIG. 18 and FIG. 19.

FIG. 21 illustrates an example 2100 of a section extension according to embodiments of the present disclosure. The example of a section extension illustrated in FIG. 21 is for illustration only. Different embodiments of a section extension could be used without departing from the scope of this disclosure.

In the example of FIG. 21, similar to FIG. 18, the dimension of all the port-groups are signaled. The least index is transferred after the reserved bit.

Although FIG. 21 illustrates an example 2100 of a section extension, various changes may be made to FIG. 21. For example, various changes to the number of fields, the arrangement of the fields, etc. could be made according to particular needs.

FIG. 22 illustrates an example 2200 of a section extension according to embodiments of the present disclosure. The example of a section extension illustrated in FIG. 22 is for illustration only. Different embodiments of a section extension could be used without departing from the scope of this disclosure.

In the example of FIG. 22, similar to FIG. 19, “isDimRep” is used to save 16 bits for signaling the dimension of the next port-group, if they have the same dimension:
Field “isDimRep”: 1 bit to indicate if the next port-group has the same dimension.
   If False, the dimension of the next port-group will be signaled.
   If True, the dimension next port-group will not be omitted and will signal the second from the next port-group (if exist).

Regardless of whether the dimension of a port-group is signaled, the least index is signaled. As shown in FIG. 22, the “isDimRep1” is 0, the dimension of the port-group 2 (next from 1) is signaled. Since the “isDimRep2” is 1, the dimension of the port-group 3 (next from 2) is not signaled and assumed to be the same as the port-group 2. The least indexes are signaled per port-group.

Although FIG. 22 illustrates an example 2200 of a section extension, various changes may be made to FIG. 22. For example, various changes to the number of fields, the arrangement of the fields, etc. could be made according to particular needs.

For each port-group in dimension [Nᵥⁱ×Nₕⁱ×Nₚⁱ], the number of the port is defined as Nⁱ=Nᵥⁱ*Nₕⁱ*Nₚⁱ, where i is the index of the port-group. The spatial combining achieves an Nⁱ-to-1 spatial combining. Nⁱ weights are used corresponding to the Nⁱ ports. The weights are multiplied with the signal on the ports and the summation of the multiplications is the spatial combining result of the i^{th} port-group. The DU configures the parameters for the RU in accordance with step 7 of FIG. 10. In some embodiment the port-groups share the same weights, and the DU configures one set of the parameters. In some embodiments the port-groups share different weights, and the DU configures the parameters of each port-group for the RU.

In some embodiments the RU has the resources, e.g., CSI, codebook, etc., for spatial combining in the RU's memory. The DU transfers parameters to configure the RU to generate the weights from the resources.

In one embodiment, the spatial combining weights are chosen from a codebook, which has finite and discrete choices. The spatial combining weights can be generated by the RU based on the index of the codebook in accordance with step 8 of FIG. 10. The DU transfers the codebook to the RU in accordance with step 3 of FIG. 10, before transferring the parameters of the spatial combining weights. Then, the DU can transfer the index of the weights in the codebook in accordance with step 7 of FIG. 10, instead of transferring the weights in the codebook, reducing the fronthaul traffic. That is to say, the above embodiment modifies the method of FIG. 10 such that:
In step 3 of FIG. 10, the DU may transfer the codebook to the RU.
In step 7 of FIG. 10, the DU may transfer the index of codebook per port-group to the RU.
In step 8 of FIG. 10, the RU generates the weights based on the codebook and index.

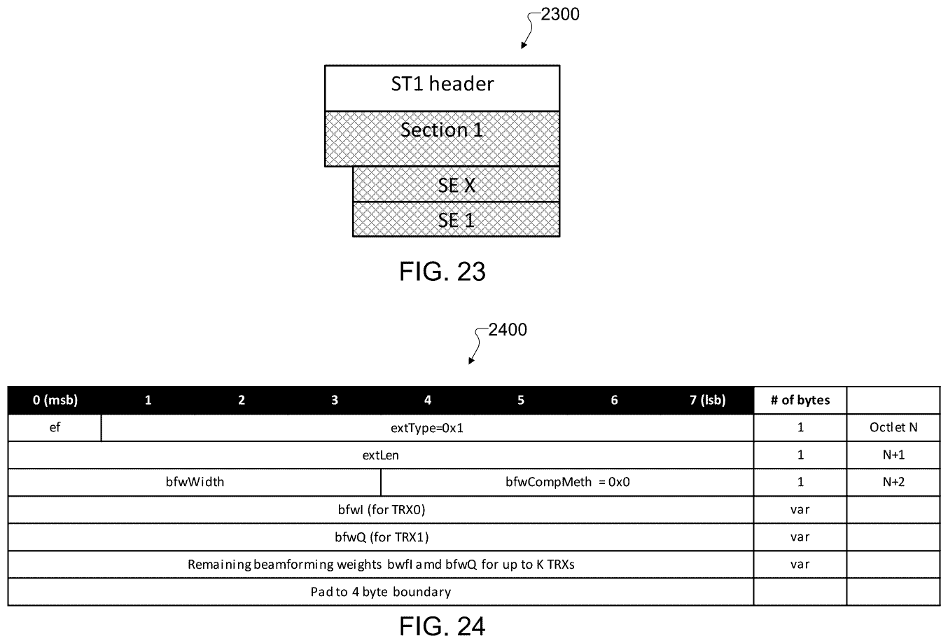

FIG. 23 illustrates an example 2300 of C-plane signaling with codebook based spatial combining according to embodiments of the present disclosure. The example of C-plane signaling illustrated in FIG. 23 is for illustration only. Different embodiments of a C-plane signaling could be used without departing from the scope of this disclosure.

In the example of FIG. 23:
1. ST1 is used to transfer the frame, subframe, slot and PRB range of the data to which the spatial combining will be applied. Each section of ST1 is signaled one option of spatial combining that the RU can choose from.
2. In each section, SE X is used to transfer the port-grouping as explained in
3. Behind SE X, SE1 is used to transfer the codebook index per port-group. SE 1 is defined/exists in the ORAN CUP-plane spec. An example of using SE1 is shown in FIG. 24.

Although FIG. 23 illustrates an example 2300 of C-plane signaling with codebook based spatial combining, various changes may be made to FIG. 23. For example, various changes to the number of sections, the section extensions, etc. could be made according to particular needs.

FIG. 24 illustrates an example 2400 of SE1 used for C-plane signaling with codebook based spatial combining according to embodiments of the present disclosure. The example of SE1 illustrated in FIG. 24 is for illustration only. Different embodiments of a section extension could be used without departing from the scope of this disclosure.

The fields of FIG. 24 are signaled as follows:
Field “bfwWidth”: the bit-width per index of the codebook.
Field “bfwCompMath”: set as 0x0 (0000b), i.e., no compression. Thus, the Field “bfwCompParam” is absent according to the ORAN CUP-plane spec.
Field “bfwI” and “bfwQ”: the indexes of the codebook per port-group are signaled. The following variations to SE1 is made:
   i. The index is a real number. Therefore, the actual information signaled is: “idx1”, “idx2”, etc.
   ii. Each index uses the bit-width as indicated by “bfwWidth”.
   iii. The order of the indexes is the same to the order of the port-groups in the SE X.

Although FIG. 24 illustrates an example 2400 of SE1 used for C-plane signaling with codebook based spatial combining, various changes may be made to FIG. 24. For example, various changes to the number of fields, the arrangement of the fields, etc. could be made according to particular needs.

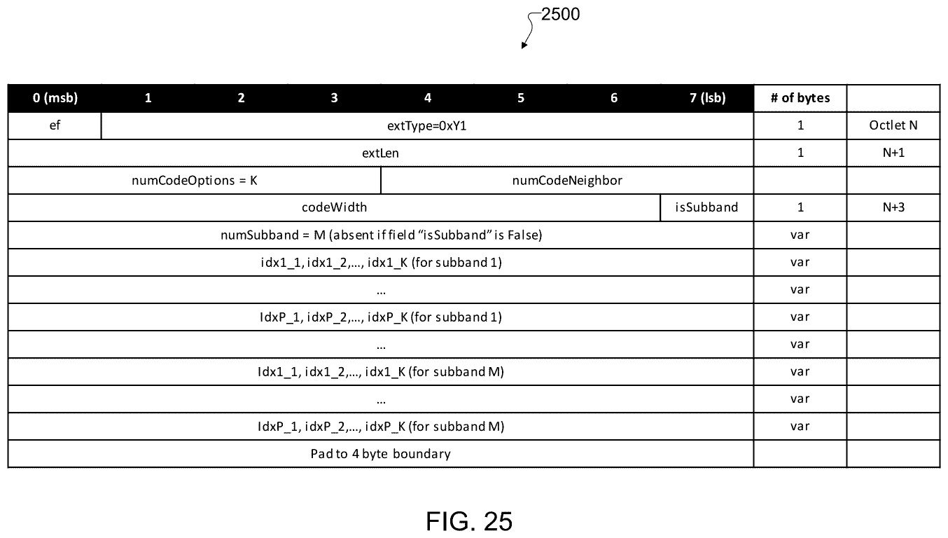

In another embodiment, the RU is allowed to select from multiple indexes per port-group and even the neighbor index within the codebook. In this example,
The DU can assign multiple codebook index options to the RU. The RU can select one from the options.
The RU is allowed to select from the neighboring codebook indexes from the assigned codebook index options.
Per subband codebook index is available.
   In this embodiment, the SE 1 in FIG. 23 is replaced by SE Y1. Then,
1. ST1 is used to transfer the frame, subframe, slot and PRB range of the data to which the spatial combining will be applied. Each section of ST1 is signaled one option of spatial combining that the RU can choose from.
2. In each section, SE X is used to transfer the port-grouping as explained in
3. Behind of SE X, SE Y1 is used to transfer the codebook index per port-group. SE Y1 is newly defined in FIG. 25 as an example.

FIG. 25 illustrates an example 2500 of SE Y1 used for C-plane signaling with codebook based spatial combining according to embodiments of the present disclosure. The example of SE Y1 illustrated in FIG. 25 is for illustration only. Different embodiments of a section extension could be used without departing from the scope of this disclosure.

The fields of the FIG. 25 are signaled as follows:
Field “numCodeOptions”: use 3 bits to indicate the number of the options of codebook index per port-group as K. Per port-group, K indexes will be transferred by DU. The RU can select from the K indexes. Specially if K=0 (000b), replace K as 8 (1000b).
Field “numCodeNeighbor”: indicate the neighboring codebook index the RU can select from the transferred codebook index.
Field “bfwWidth”: the bit-width per codebook index.
Field “isSubband”: indicate the number of the subband is M. If M=1, it indicates that the codebook indexes are transferred for the entire bandwidth; otherwise, there are M subband and the codebook indexes are transferred per subband.
Field “numSubband”: indicate the number of the subband if field “isSubband” is True, otherwise, this field is absent. The number of the subband is M. Specially, if M=1 (0x00), replace M=256 (0x100).
Field “idxA_1”, “idxA_2”, . . . , “idxA_K”: the codebook index options of port-group A. K options is transferred in a queue. If “isSubband” is True, the codebook index per subband will be transferred in a queue.

Although FIG. 25 illustrates an example 2500 of SE Y1 used for C-plane signaling with codebook based spatial combining, various changes may be made to FIG. 25. For example, various changes to the number of fields, the arrangement of the fields, etc. could be made according to particular needs.

In one embodiment, the spatial combining weights is not limited by a codebook and can use any value (e.g., the spatial combining is a free form method). One embodiment of a free-form method is the maximum ratio combining (MRC). MRC uses the CSI as the spatial combining weights which is in a free-form. The CSI is available based on SRS CE performed at the RU for each UL layer. Thus, the SRS CSI exists in the memory of the RU. So, the RU can easily perform MRC spatial combining. In this example, it is a waste of fronthaul bandwidth and unnecessary to transfer the weights from the DU to the RU. Besides, the DU can transfer configuration of MRC spatial combining such as the port-group per spatial combining, for the purpose of receiver SINR improvement.

The spatial combining is performed in a per port-group and per UL layer manner. For the i^{th} port-group, assume the revived PUSCH signal is yᵢ∈C^{16×1} (vectorized) in a RE. For the l^{th} UL layer, assume the SRS CSI of the i^{th} port-group is h_{i,l}∈C^{16×1}. The MRC of the i^{th} port-group and the l^{th} UL layer is y_{i,l}^{MRC}=h_{i,l}^{H}yᵢ∈C^{1×1}.

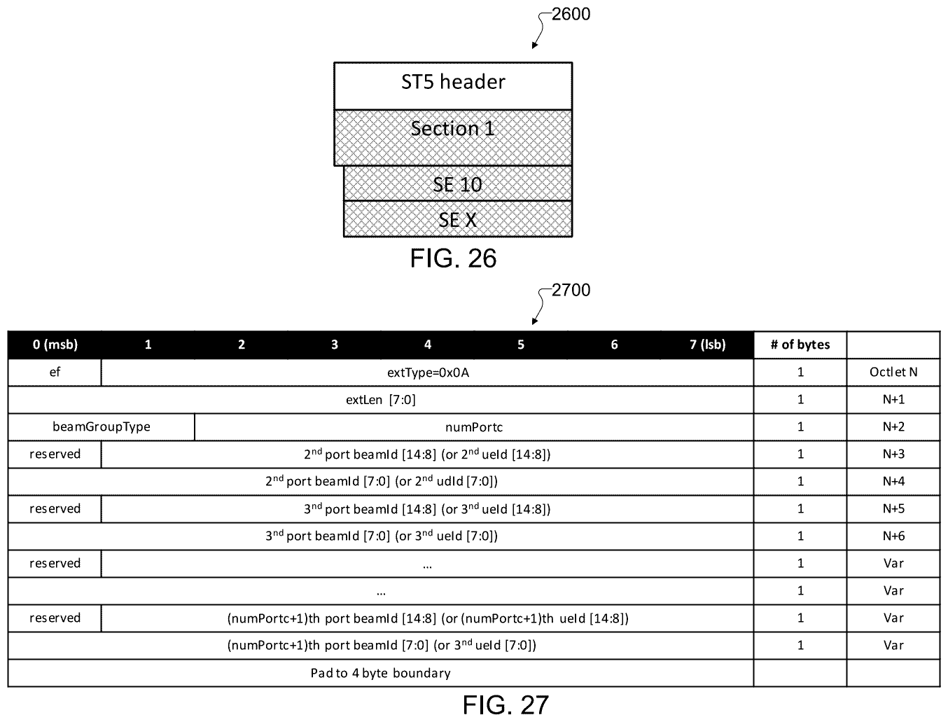

FIG. 26 illustrates an example 2600 of C-plane signaling with free-form spatial combining according to embodiments of the present disclosure. The example of C-plane signaling illustrated in FIG. 26 is for illustration only. Different embodiments of a C-plane signaling could be used without departing from the scope of this disclosure.

In the example of FIG. 26, MRC spatial combining is configured through the C-plane. The SE10 shown in FIG. 27 can be used to transfer the UE identification (in field related to “ueId”) of each layer share the same physical resource. The SE X is used to indicate the port-group division. In this way, the RU is able obtain the identification of each layer and the port-group division. The MRC spatial combining weights can be generated by using the SRS CSI at the RU.

Although FIG. 26 illustrates an example 2600 of C-plane signaling with free-form spatial combining, various changes may be made to FIG. 26. For example, various changes to the number of sections, the section extensions, etc. could be made according to particular needs.

FIG. 27 illustrates an example 2700 of SE10 used for C-plane signaling with codebook based spatial combining according to embodiments of the present disclosure. The example of SE10 illustrated in FIG. 27 is for illustration only. Different embodiments of a section extension could be used without departing from the scope of this disclosure. Although FIG. 27 illustrates an example 2700 of SE10 used for C-plane signaling with free-form spatial combining, various changes may be made to FIG. 27. For example, various changes to the number of fields, the arrangement of the fields, etc. could be made according to particular needs.

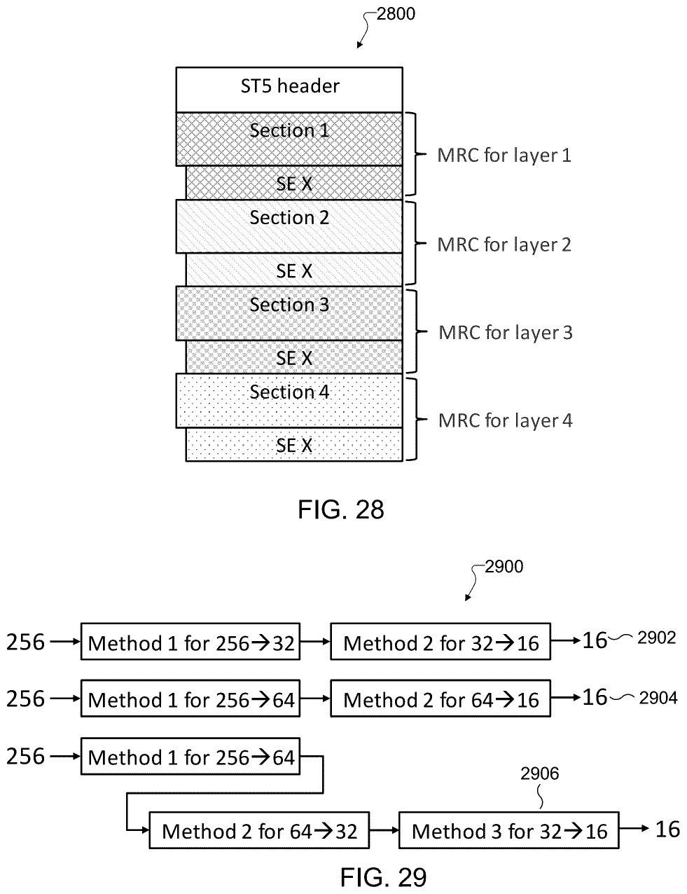

Another embodiment of configuring MRC spatial combining through the C-plane is shown in FIG. 28.

FIG. 28 illustrates an example 2800 of C-plane signaling for spatial combining according to embodiments of the present disclosure. The example of C-plane signaling illustrated in FIG. 28 is for illustration only. Different embodiments of a C-plane signaling could be used without departing from the scope of this disclosure.

In the example of FIG. 28, In each section of the ST5, the DU can transfer per ueId spatial combining to the RU. Each section contains the full ueId of a certain layer. Each section has a section extension X for indicating the port-group division of the certain ueId.

Although FIG. 28 illustrates an example 2800 of C-plane signaling for spatial combining, various changes may be made to FIG. 28. For example, various changes to the number of sections, the section extensions, etc. could be made according to particular needs.

Instead of using one method to achieve the spatial combining, e.g., from 256 ports to 16 ports, it is feasible to use multiple spatial combining methods jointly. For example, the methods can be used serially or in parallel (or a combination of the two), e.g., serial spatial combining and parallel spatial combining. The combination of the serial spatial combining and parallel spatial combining is referred to herein as hybrid spatial combining. When using hybrid spatial combining, the RU may select from several options of spatial combining weights.

FIG. 29 illustrates examples 2900 of serial spatial combining according to embodiments of the present disclosure. The examples serial spatial combining illustrated in FIG. 29 are for illustration only. Different embodiments of serial spatial signaling could be used without departing from the scope of this disclosure.

In FIG. 29, three examples of serial spatial combining 2902-2906 are illustrated. Each block represents a spatial combining method. The 256-to-16 spatial combining is achieved by two or three or even more spatial combining methods in a queue. The spatial combining methods 1, 2, 3, etc. shown in the FIG. 29 can be codebook based spatial combining, free-form spatial combining, or any other spatial combining methods.

Although FIG. 29 illustrates examples 2900 of serial spatial combining, various changes may be made to FIG. 29. For example, various changes to the spatial combining methods, the number of spatial combining methods, etc. could be made according to particular needs.

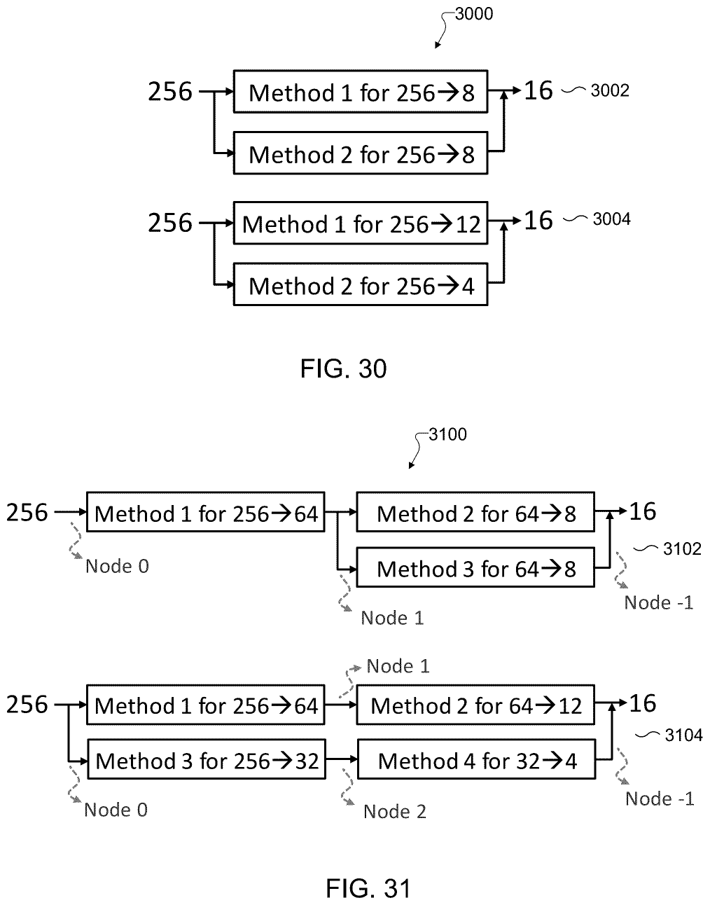

FIG. 30 illustrates examples 3000 of parallel spatial combining according to embodiments of the present disclosure. The examples parallel spatial combining illustrated in FIG. 30 are for illustration only. Different embodiments of parallel spatial signaling could be used without departing from the scope of this disclosure.

In FIG. 30 two examples of parallel spatial combining 3002-3004 are illustrated. The 256-to-16 spatial combining is achieved by two or more separate spatial combining methods. The spatial combining methods 1, 2, etc. shown in the FIG. 30 can be codebook based spatial combining, free-form spatial combining, or any other spatial combining methods.

Although FIG. 30 illustrates examples 3000 of parallel spatial combining, various changes may be made to FIG. 30. For example, various changes to the spatial combining methods, the number of spatial combining methods, etc. could be made according to particular needs.

FIG. 31 illustrates examples 3100 of hybrid spatial combining according to embodiments of the present disclosure. The examples of hybrid spatial combining illustrated in FIG. 31 are for illustration only. Different embodiments of parallel spatial signaling could be used without departing from the scope of this disclosure.

In FIG. 31 two examples of parallel spatial combining 3102-3104 are illustrated including serial and parallel cascading of the spatial combining methods. The 256-to-16 spatial combining is achieved by two or more separate parallelly combining branches. Each branch can be achieved by a number of serial spatial combining methods in a queue. The spatial combining methods 1, 2, 3, etc. shown in the FIG. 31 can be codebook based spatial combining, free-form spatial combining, or any other spatial combining methods. The term “hybrid connection” is defined as how the methods are connected to achieve hybrid spatial combining.

To explain the hybrid connection, the concept of a “node” to signal the connection of the spatial combining methods should be understood. Two examples are shown in FIG. 31. In the example of FIG. 31, node 0 is defined as the full-port, i.e., without spatial combining. Node −1 is defined as the final spatial combining output. In the middle of node 0 and node −1, multiple nodes are defined as the output of spatial combining methods. For each spatial combining method, by defining the input and the output of node, the hybrid connection can be known.

Although FIG. 31 illustrates examples 3100 of hybrid spatial combining, various changes may be made to FIG. 31. For example, various changes to the spatial combining methods, the number of spatial combining methods, etc. could be made according to particular needs.

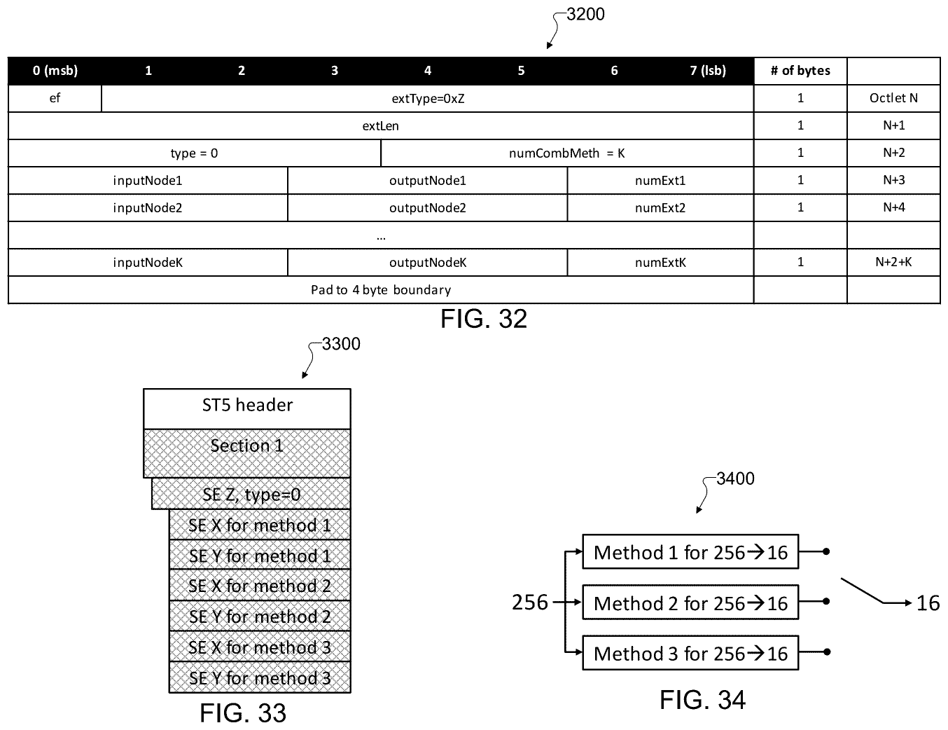

To transfer the hybrid connection among the spatial combining methods, SE Z as illustrated in FIG. 32 can be used as an example.

FIG. 32 illustrates an example 3200 of SE Z used for signaling for hybrid spatial combining according to embodiments of the present disclosure. The example of SE Z illustrated in FIG. 32 is for illustration only. Different embodiments of a section extension could be used without departing from the scope of this disclosure.

The fields of FIG. 32 are signaled as follows:
Field “numCombMeth”: the total number of K of the spatial combining methods.
Field “type”: the format of SE Z. An example is shown in FIG. 32 where “type” is 1. In this “type=1”, there are 8 nodes can be used to represent the hybrid connection, including node 0 and node −1 (111b). Besides, up to 4 EX can be used per method.
Field “inputNode”: the index of the input node of each spatial combining method. The value of “inputNode” cannot be 7 (111b), i.e., “inputNode” cannot represent the output of the spatial combining.
Field “outputNode”: the index of the output node of each spatial combining method. If the value of “inputNode” is 7 (111b), it representing the node −1.
Field “numExt”: the number of the section extensions used of each method.

Although FIG. 32 illustrates an example 3200 of SE Z used for signaling for hybrid spatial combining, various changes may be made to FIG. 32. For example, various changes to the number of fields, the arrangement of the fields, etc. could be made according to particular needs.

By knowing the input node and output node of each spatial combining methods, the RU will know the hybrid connection. By knowing the number of section extension per method, the RU is able to generate the spatial combining weights for that method. To this end, the RU can generate the spatial combining weight of the entire hybrid combining.

FIG. 33 illustrates an example 3300 of using SE Z and SE per method to transfer the spatial combining configuration according to embodiments of the present disclosure. The example of using SE Z and SE per method illustrated in FIG. 33 is for illustration only. Different embodiments of using SE Z and SE per method could be used without departing from the scope of this disclosure.

In the example of FIG. 33, the DU transfers one option of a hybrid spatial combining associated with three methods.

Although FIG. 33 illustrates an example 3300 of using SE Z and SE per method to transfer the spatial combining configuration, various changes may be made to FIG. 33. For example, various changes to the number of sections, the section extensions, etc. could be made according to particular needs.

In some embodiments, the DU can transfer multiple spatial combining options, and the RU can select from the options and perform the spatial combining, as illustrated in FIG. 34.

FIG. 34 illustrates an example 3400 of multiple spatial combining options according to embodiments of the present disclosure. The example of multiple spatial combining options illustrated in FIG. 34 is for illustration only. Different embodiments of multiple spatial combining options could be used without departing from the scope of this disclosure.

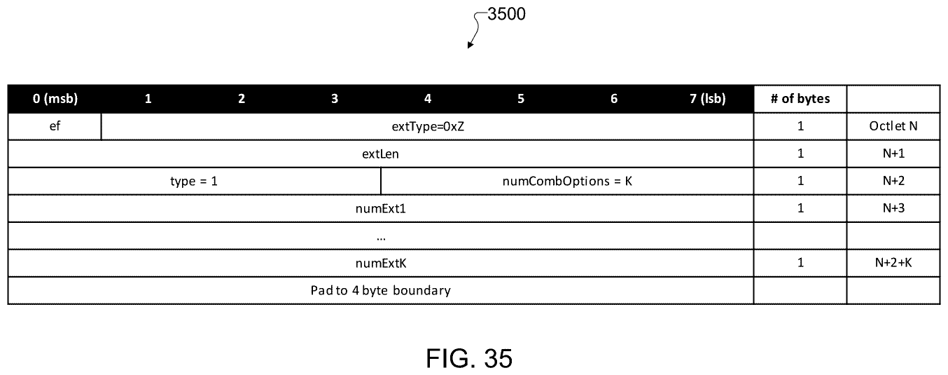

In the example of FIG. 34, The DU may indicate the options by SE Z using field “type=1” as shown in FIG. 35.

Although FIG. 34 illustrates an example 3400 of multiple spatial combining options, various changes may be made to FIG. 34. For example, various changes to the spatial combining methods, the number of spatial combining methods, etc. could be made according to particular needs.

FIG. 35 illustrates an example 3500 of using SE Z to transfer multiple spatial combining options according to embodiments of the present disclosure. The example of using SE Z to transfer multiple spatial combining options illustrated in FIG. 35 is for illustration only. Different embodiments of using SE Z to transfer multiple spatial combining options could be used without departing from the scope of this disclosure.

In the Example of FIG. 35, The SE Z has fields “numCombOptions=K” which indicates there are K spatial combining options will be transferred. The field “numExt” indicates the number of sections extension of each options.

Although FIG. 35 illustrates an example 3500 of using SE Z to transfer multiple spatial combining options, various changes may be made to FIG. 35. For example, various changes to the number of fields, the arrangement of the fields, etc. could be made according to particular needs.

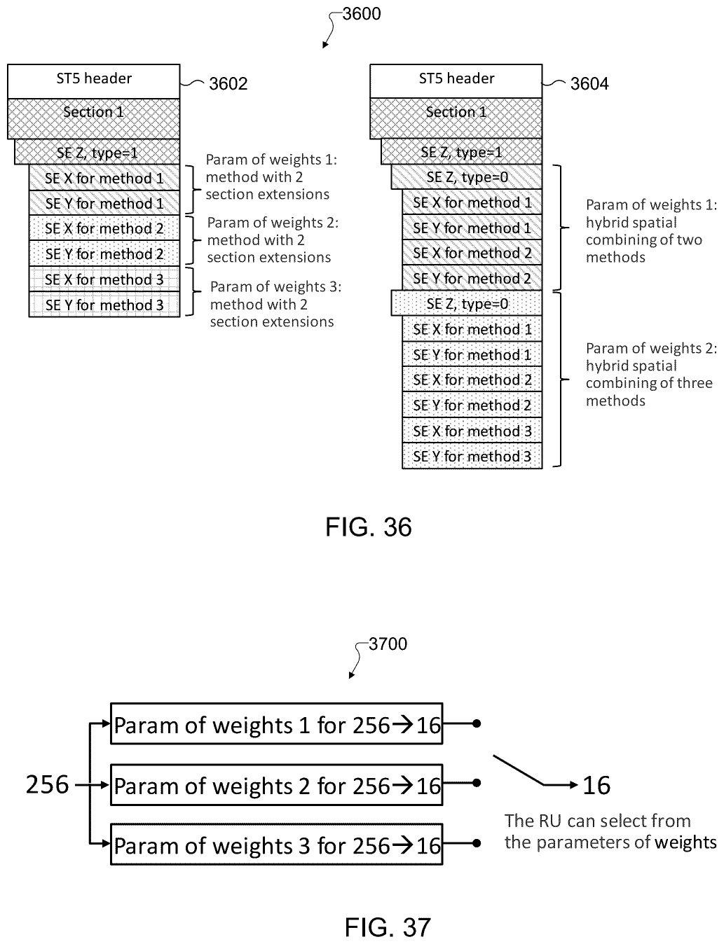

FIG. 36 illustrates examples 3600 of using SE Z to transfer multiple spatial combining options according to embodiments of the present disclosure. The example of using SE Z to transfer multiple spatial combining options illustrated in FIG. 36 is for illustration only. Different embodiments of using SE Z to transfer multiple spatial combining options could be used without departing from the scope of this disclosure.

In FIG. 36 two example 3602-3604 of utilizing SE Z to indicating the multiple spatial combining options are illustrated. In example 3602, SE Z with “type=1” is followed by three spatial combining options. Each option contains two section extensions. In this way, the field “numCombOptions” is K=3, and all “numExt1”, “numExt2”, and “numExt3” are 2. In example 3604, the SE Z with “type=1” is followed by two options of hybrid spatial combining. The first option is a hybrid of two method. The total number of section extension of this option is 5, including a SE Z with “type=0” and 4 SE for two methods. The second option is a hybrid of three methods. The total number of SEs of this option is 7, including a SE Z with “type=0” and 6 SE for three methods. In this way, the field “numCombOptions” is K=2, “numExt1” is 5, and “numExt2” is 7.

Although FIG. 36 illustrates examples 3600 of using SE Z to transfer multiple spatial combining options, various changes may be made to FIG. 36. For example, various changes to the number of sections, the section extensions, etc. could be made according to particular needs.

At the RU side, the RU may see multiple options of parameters for spatial combining weights, as shown in FIG. 37. Each option of parameters for spatial combining weights may comprise a single method or a hybrid of methods.

FIG. 37 illustrates an example 3700 of multiple options of parameters for spatial combining weights according to embodiments of the present disclosure. The example of multiple options of parameters for spatial combining weights illustrated in FIG. 37 is for illustration only. Different embodiments of multiple options of parameters for spatial combining weights could be used without departing from the scope of this disclosure. Although FIG. 37 illustrates an example 3700 of multiple options of parameters for spatial combining weights, various changes may be made to FIG. 37. For example, various changes to the parameters, the number of options, etc. could be made according to particular needs.

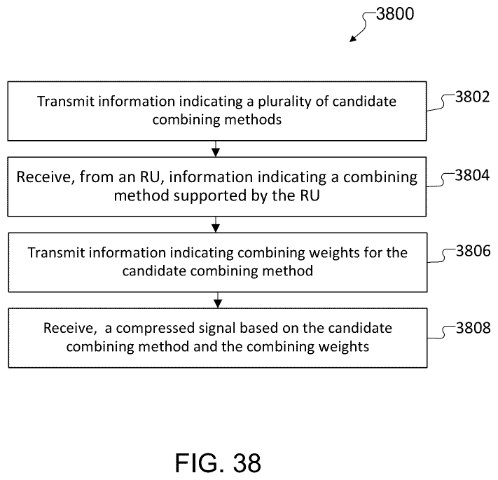

FIG. 38 illustrates a method 3800 for spatial combining of UL in MIMO systems according to embodiments of the present disclosure. An embodiment of the method illustrated in FIG. 38 is for illustration only. One or more of the components illustrated in FIG. 38 may be implemented in specialized circuitry configured to perform the noted functions or one or more of the components may be implemented by one or more processors executing instructions to perform the noted functions. Other embodiments of spatial combining of UL in MIMO systems could be used without departing from the scope of this disclosure.

As illustrated in FIG. 38, the method 3800 begins at step 3802. At step 3802, a distributed unit such as such as DU 610 of FIG. 6, transmits information indicating a plurality of candidate combining methods. At step 3804, the DU receives, from a radio unit such as RU 620 of FIG. 6, information indicating a combining method supported by the RU. At step 1306, the DU transmits information indicating combining weights for the candidate combining method. Finally, at step 3808, the DU receives a compress signal from the RU. The compressed signal is based on the candidate combining method and at least one of the combining weights.

Although FIG. 38 illustrates one example of a method 3800 for spatial combining of UL in MIMO systems, various changes may be made to FIG. 38. For example, while shown as a series of steps, various steps in FIG. 38 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A distributed unit (DU) comprising:
a processor; and
a transceiver operatively coupled to the processor, the transceiver configured to:
transmit information indicating a plurality of candidate combining methods; and
receive a compressed signal, wherein the compressed signal is based on at least one of the candidate combining methods.

2. The DU of claim 1, wherein:
the transceiver is further configured to:
receive, from a radio unit (RU), information indicating a combining method supported by the RU, from the plurality of candidate combining methods; and
transmit information indicating combining weights for the combining method, and the compressed signal is based on at least one of the combining weights.

3. The DU of claim 2, wherein:
the transceiver is further configured to receive sounding reference signal (SRS) channel state information (CSI), and
the combining weights are based on the SRS CSI.

4. The DU of claim 2, wherein the combining weights are chosen based on at least one of a plurality of port groups, a codebook, and a channel state information (CSI).

5. The DU of claim 1, wherein:
the processor is configured to:
generate a control message comprising:
a section extension type field indicating a section extension type used when partitioning port groups;
at least one numVer field indicating a number of ports in a vertical dimension of an associated port-group;
at least one numPolar field indicating a number of polarizations of the associated port-group; and
at least one numHori field indicating a number of ports in a horizontal dimension of the associated port-group; and
the transceiver is further configured to transmit the control message.

6. The DU of claim 5, wherein:
the control message further comprises at least one of:
a spatialCombMeth field indicating an index of the candidate combining methods; and
at least one isDimRep field indicating if the associated port-group has a same dimension; and
the isDimRep field corresponds to the at least one numVer field, the at least one numPolar field, and the at least one numHori field.

7. The DU of claim 5, wherein:
the control message further comprises at least one leastPortIndex field indicating a least index of an antenna port in the associated port-group; and
the leastPortIndex field corresponds to the at least one numVer field, to the at least one numPolar field, and to the at least one numHori field.

8. A radio unit (RU) comprising:
a processor; and
a transceiver operatively coupled to the processor, the transceiver configured to:
receive information indicating a plurality of candidate combining methods; and
transmit a compressed signal, wherein the compressed signal is based on at least one of the candidate combining methods.

9. The RU of claim 8, wherein:
the transceiver is further configured to:
transmit, information indicating a combining method supported by the RU, from the plurality of candidate combining methods; and
receive, from a distributed unit (DU), information indicating combining weights for the combining method, and
the compressed signal is based on at least one of the combining weights.

10. The RU of claim 9, wherein:
the transceiver is further configured to:
transmit sounding reference signal (SRS) channel state information (CSI), and the combining weights are based on the SRS CSI.

11. The RU of claim 9, wherein the combining weights are chosen based on at least one of a plurality of port groups, a codebook, and a channel state information (CSI).

12. The RU of claim 8, wherein:
the transceiver is further configured to:
receive a control message comprising:
a section extension type field indicating a section extension type used when partitioning port groups;
at least one numVer field indicating a number of ports in a vertical dimension of an associated port-group;
at least one numPolar field indicating a number of polarizations of the associated port-group; and
at least one numHori field indicating a number of ports in a horizontal dimension of the associated port-group.

13. The RU of claim 12, wherein:
the control message further comprises at least one of:
a spatialCombMeth field indicating an index of the candidate combining methods; and
at least one isDimRep field indicating if the associated port-group has a same dimension; and
the isDimRep field corresponds to the at least one numVer field, the at least one numPolar field, and the at least one numHori field.

14. The RU of claim 12, wherein:
the control message further comprises at least one leastPortIndex field indicating a least index of an antenna port in the associated port-group; and
the leastPortIndex field corresponds to the at least one numVer field, to the at least one numPolar field, and to the at least one numHori field.

15. A method of operating distributed unit (DU), the method comprising:
transmitting information indicating a plurality of candidate combining methods; and
receiving a compressed signal, wherein the compressed signal is based on at least one of the candidate combining methods.

16. The method of claim 15, further comprising:
receiving, from a radio unit (RU), information indicating a combining method supported by the RU, from the plurality of candidate combining methods; and
transmitting information indicating combining weights for the combining method,
wherein the compressed signal is based on at least one of the combining weights.

17. The method of claim 16, wherein the combining weights are chosen based on at least one of a plurality of port groups, a codebook, and a channel state information (CSI).

18. The method of claim 15, further comprising:
generating a control message comprising:
a section extension type field indicating a section extension type used when partitioning port groups;
at least one numVer field indicating a number of ports in a vertical dimension of an associated port-group;
at least one numPolar field indicating a number of polarizations of the associated port-group; and
at least one numHori field indicating a number of ports in a horizontal dimension of the associated port-group; and
transmitting the control message.

19. The method of claim 18, wherein:
the control message further comprises at least one of:
a spatialCombMeth field indicating an index of the candidate combining methods; and
at least one isDimRep field indicating if the associated port-group has a same dimension; and
the isDimRep field corresponds to the at least one numVer field, the at least one numPolar field, and the at least one numHori field.

20. The method of claim 18, wherein:
the control message further comprises at least one leastPortIndex field indicating a least index of an antenna port in the associated port-group; and
the leastPortIndex field corresponds to the at least one numVer field, to the at least one numPolar field, and to the at least one numHori field.
